(19) United States
(12) Patent Application Publication
(10) Pub. No.: US 2004/0165518 A1
(43) Pub. Date: Aug. 26, 2004

(54) Optical information-recording medium, optical information recording apparatus and optical information reproducing apparatus including optical information-recording medium and method for manufacturing polarization changing layer

(75) Inventors: Hideyoshi Horimai, Yokohama-shi (JP); Yasuo Sakane, Yokohama-shi (JP); Kazuhiko Kimura, Yokohama-shi (JP)

Correspondence Address: KODA & ANDROLIA, 2029 CENTURY PARK EAST, SUITE 1430, LOS ANGELES, CA, 90067-3024, US

(73) Assignee: Optware Corporation

(21) Appl. No.: 10/725,717

(22) Filed: Dec. 2, 2003

(30) Foreign Application Priority Data
Dec. 2, 2002 (JP) 2002-350464

(51) Int. Cl. G11B 7/00

(52) U.S. Cl. 369/94; 369/275.2; 369/283

(57) ABSTRACT

An optical information-recording medium 1 is constituted by depositing a quarter-wave plate 4, a hologram-recording layer 3 and a reflection layer 5 on a transparent base plate 2 in this order. Reproducing reference light (P-polarized light) passes through the quarter-wave plate 4 to change into a circularly polarized light, and then the circularly polarized light enters the hologram-recording layer 3, so that the reproducing light (circular polarization) generated from the hologram-recording layer 3 passes through the quarter-wave plate 4 to change into a S-polarized light. On the other hand, stray light SL1 (P-polarized light) resulting from the process in which the reproducing light is reflected from the surface of the base plate or in the inside thereof has an vibration direction different from that in the stray light SL2 (P-polarized light) resulting from the process in which the reproducing reference light goes and returns in the inside of the optical information-recording medium 1. Accordingly, the stray light can be distinguished from the reproducing light, thereby making it possible to prevent the S/N ratio from deteriorating.

### BACKGROUND OF THE INVENTION

1. Field of the Invention

The present invention relates to an optical information-recording medium, in which information is recorded, utilizing the holography, an optical information recording apparatus for recording information in an optical information-recording medium, utilizing the holography, an optical information reproducing apparatus for reproducing information from an optical information-recording medium, utilizing the holography, and an optical information recording/reproducing apparatus for recording information in an optical information-recording medium and for reproducing information from the optical information-recording medium, utilizing the holography.

2. Description of the Related Art

In the holographic recording, information is recorded in a recording medium, utilizing the holography. Generally, the holographic recording is carried out by superimposing light having an image information on reference light in such a recording medium and by writing interference fringes resulting from the superimposing in the recording medium. In the reproduction of the recorded information, the image information is reproduced from the diffraction of interference fringes by irradiating a reference light to the recording medium.

In recent years, the volume holography, in particular the digital volume holography is practically developed in order to optically record information in an ultra-high density. In the volume holography, interference fringes are three-dimensionally written in a recording medium by effectively using the recording medium in the thickness direction, and an increase in the thickness causes the diffraction efficiency to be enhanced, so that the capacity of recording may be increased, utilizing the multiplex recording. In the digital volume holography, a computer-aid holographic recording method is utilized, where the image information to be recorded is restricted into digitized digital patterns, using a recording medium and a recording method similar to those in the volume holography.

In the digital volume holography, the information of an image, such as, for instance, an analog picture, is digitized and expanded in a series of two-dimensional digital pattern information (referred to as the page data), and then the information is recorded as an image information. In the reproducing operation mode, digital pattern information is read out and then decoded, so that it is displayed as the original image information. In this case, even if the reproduced signal has a relatively deteriorated magnitude of SN ratio (signal to noise ratio), the original information may be reproduced with high fidelity by employing the differential detection and/or by encoding the digitized data to apply the error correction thereto.

FIG. 1 is a schematic diagram for explaining the process of reproducing a conventional digital volume hologram in Japanese Unexamined Patent Application Publication No. 11-311938 (corresponding to FIG. 10 therein).

P-polarized light emitted from a light source (not shown) impinges on an optical rotation plate 201L in a dual-divided optical rotation plate 201 via optical elements (not shown), such as a lens, a beam splitter and the like. The light arrived at the optical rotation plate 201L further passes through the optical rotation plate 201L to form a reproducing reference light 153L. The reproducing reference light 153L thus formed is an A-polarized light. The reproducing reference light 153L is incident upon an optical information-recording medium 101 via an objective 112. The reproducing reference light 153L is focused on the surface of a hologram layer 103 and then passes through the hologram layer 103 in the form of a divergent beam. As a result, a reproduced light 154L is generated from the hologram layer 103. The reproducing light 154L is also an A-polarized light. The reproducing light 154L propagates on the side of the objective 112 and is collimated into a parallel light beam by the objective 112. The reproducing light 154L thus collimated passes through an optical rotation plate 201R in the dual-divided optical rotation plate 201 to form an S-polarized light.

The reproduced light thus passed through the dual-divided optical rotation plate 201 impinges upon a CCD array (not shown) via optical elements (not shown), such as a prism block and the like, so that the information in the detected signal is reproduced.

In the above-mentioned reproduction of information, however, a stray light component resulting from the surface reflection and/or from scattering is generated in the optical information-recording medium 101 as well as in optical elements, such as the objective 112 and other. Such a stray light component is also detected by the CCD array, which is used to detect the recorded information. Hence, the stray light component provides noise, thereby causing the S/N ratio (signal to noise ratio) to be deteriorated.

### SUMMARY OF THE INVENTION

Accordingly, it is an object of the present invention to suppress the deterioration of the S/N ratio resulting from the stray light component.

According to the present invention as described in claim 1, an optical information-recording medium, includes: an information-recording layer in which information is recorded, utilizing the holography; a polarization-changing layer for changing the polarizing direction of the light passing therethrough; and a reflection layer, disposed far away from the information-recording layer and the polarization-changing layer viewed from the incident side of the light, for reflecting the light.

In accordance with the above structural arrangement according to the present invention, the stray light resulting from optical elements disposed closer to the optical information-recording medium on the side of the incident light has a vibration direction different from that in the reproducing light emanating from the information-recording layer when a light beam impinges thereon. As a result, the stray light and reproduced light may be distinguished from each other, thereby making it possible to suppress the deterioration of the S/N ratio resulting from the stray light component.

The present invention as described in claim 2, is an optical information-recording medium according to claim 1, wherein the polarization-changing layer is disposed closer to the information-recording layer, viewed from the incident side of light, and is in contact with the information-recording layer.

In accordance with the above-described structural arrangement according to the present invention, stray light resulting from optical elements closer to the information-recording layer on the side of the incident light may be distinguished from reproducing light, thereby making it possible to suppress the deterioration of the S/N ratio resulting from the stray light component.

The present invention as described in claim 3, is an optical information-recording medium according to claim 2, wherein the information-recording layer is in contact with the reflection layer.

In accordance with the above-described structural arrangement according to the present invention, the reflection layer is located far away from the information-recording layer, viewed from the side of the incident light and therefore there is no optical element which generates the stray light. Hence, the stray light component may be reduced.

The present invention as described in claim 4, is an optical information-recording medium according to claim 1, wherein the polarization-changing layer is disposed far away from the information-recording layer, viewed from the incident side of light, and is in contact with the reflection layer.

In accordance with the above-described structural arrangement according to the present invention, the reflection layer is located far away from the polarization changing layer, viewed from the side of the incident light, and therefore there is no optical element which generates the stray light. Hence, the stray light component may be reduced.

The present invention as described in claim 5, is an optical information-recording medium according to claim 4, wherein the polarization-changing layer is in contact with the information-recording layer.

In accordance with the above-described structural arrangement according to the present invention, the recording reference light which is used to record a piece of information on the information-recording layer has a vibration direction different from that in the reflected light which is formed by the reflection from the information-recording layer after the incidence of the recording reference light. As a result, a hologram resulting from the recording reference light is formed, but a hologram resulting from the reflected light is not formed.

The present invention as described in claim 6, is an optical information-recording medium according to one of claims 1 to 5, wherein the polarization layer includes: a base plate; and a phase difference-generating layer for generating a phase difference in the light which is incident on the polarization-changing layer; whereby molecules in the phase difference-generating layer are arranged along a circle on the substrate.

In accordance with the above-described structural arrangement according to the present invention, it follows that the optical information-recording medium includes a polarization changing layer which is suitable for recording or reproducing the information in the state of rotating the optical information-recording medium.

The present invention as described in claim 7, is a method for manufacturing a polarization-changing layer which includes a base plate and a phase difference-generating layer for generating a phase difference in the incident light, wherein molecules in the phase difference-generating layer are arranged along a circle on the base plate, the method including the following steps of: applying a phase difference material providing the phase difference-generating layer onto the base plate; and irradiating a linearly polarized light to the phase difference material in the state of rotating the substrate; whereby the phase difference material is disposed in a predetermined direction with respect to the linearly polarized light.

In accordance with the above-described structural arrangement according to the present invention, the polarization changing layer in which phase difference generating materials are arranged along a circle on the base plate may be produced.

The present invention as described in claim 8, is a method for manufacturing a polarization-changing layer according to claim 7, wherein the phase difference material is azobezene, and the linearly polarized light has an oscillating plane which is aligned in the radial direction of rotation when the base plate is rotated.

The present invention as described in claim 9, is a method for manufacturing a polarization-changing layer which includes a base plate having an orientation layer on the surface and a phase difference-generating layer for generating a phase difference in the incident light, wherein molecules in the phase difference-generating layer are arranged along a circle on the base plate, the method including the following steps of: rubbing the orientation layer; applying a phase difference material providing the phase difference-generating layer onto the base plate; and rotating the base plate.

In accordance with the above-described structural arrangement according to the present invention, the polarization changing layer in which phase difference generating materials are arranged along a circle on the base plate may be produced.

The present invention as described in claim 10, is an optical information recording apparatus for recording information in an optical information-recording medium according to one of claims 1 to 6, the optical information recording apparatus including: an information light generating unit for generating information light carrying information; a recording reference light generating unit for generating recording reference light; and a recording optics for irradiating information light and recording reference light onto information-recording layer from one side thereof to record the information on the information-recording layer of the optical information-recording medium by means of an interference pattern provided by interfering the information light and the recording reference light with each other.

The present invention as described in claim 11, is an optical information reproducing apparatus for reproducing information from an optical information-recording medium according to one of claims 1 to 6, the optical information reproducing apparatus including: a reproducing reference light generating unit for generating reproducing reference light; a reproducing optics for collecting reproducing light from information-recording layer of the optical information-recording medium on the same side of the reproducing reference light irradiated onto the information-recording layer by irradiating the reproducing reference light onto the information-recording layer; and a detection unit for detecting the reproducing light collected by the reproducing optics.

According to the present invention as described in claim 12, an optical information reproducing apparatus according to claim 11, further includes; a noise suppressing unit interposed between the reproducing optics and the detection unit for penetrating only a linearly polarized light which has the same vibration direction as that in the circularly polarized light penetrating the polarization-changing layer of the optical information-recording layer.

In accordance with the above-described structural arrangement according to the present invention, the stray light component can be removed from the reproducing light collected by the reproduction optics with the aid of the noise suppressing means, thereby making it possible to suppress the reduction of the S/N ratio resulting from the stray light component.

Further objects, features and advantages of the present invention will become apparent from the following description of the preferred embodiments with reference to the accompanying drawings.

### BRIEF DESCRIPTION OF THE DRAWINGS

FIG. 1 is a schematic diagram showing the recording in a conventional hologram recording method;

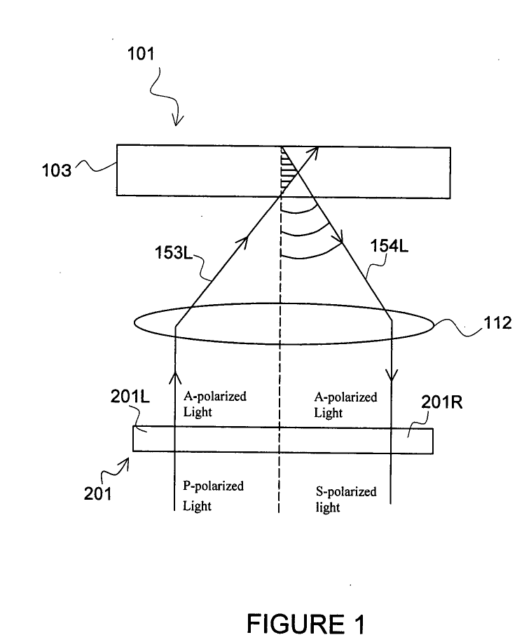

FIG. 2 shows an optical arrangement of a pick up system and an optical information-recording medium in an optical information recording/reproducing apparatus of a first embodiment;

FIG. 3 is a block diagram of the total system in the optical information recording/reproducing apparatus of the first embodiment;

FIG. 4 is a sectional view of the optical information-recording medium of the first embodiment;

FIG. 5 is a block diagram of a detection circuit in FIG. 3;

FIG. 6 shows the optical arrangement of the pick up system of FIG. 2 in the servo operation mode;

FIG. 7 shows the optical arrangement of the pick up system of FIG. 2 in the recording operation mode;

FIG. 8 shows ray diagrams of recording reference light and information light in the recording operation mode before and after they are incident on a quarter-wave plate in the pick up system shown in FIG. 7;

FIG. 9 is a ray diagram showing the detail of recording in the pick up system shown in FIG. 8;

FIG. 10 is another ray diagram showing the detail of recording in the pick up system shown in FIG. 8;

FIG. 11 shows the optical arrangement of the pick up system of FIG. 2 in the reproducing operation mode;

FIG. 12 is ray diagrams of recording reference light and information light in the recording operation mode before and after they are incident on a quarter-wave plate in the pick up system shown in FIG. 11;

FIG. 13 is a ray diagram showing the detail of reproduction in the pick up system shown in FIG. 11;

FIG. 14 is another ray diagram showing the detail of reproduction in the pick up system shown in FIG. 11;

FIG. 15 shows diagrams explaining the function of a shielding mask for rejecting the reproducing reference light reflected from the surface of the optical information-recording medium;

FIG. 16 is a diagram showing the polarizing state of stray light and reproducing light in the case of irradiating reproducing reference light 64L and 64R;

FIG. 17 is a sectional view of an optical information-recording medium in a second embodiment;

FIG. 18 is a ray diagram showing the detail of recording in the pick up system;

FIG. 19 is a partially enlarged ray diagram in the vicinity of the optical information-recording medium 1 in FIG. 18;

FIG. 20 is another ray diagram showing the detail of recording in the pick up system;

FIG. 21 is a partially enlarged ray diagram in the vicinity of the optical information-recording medium 1 in FIG. 20;

FIG. 22 is a ray diagram showing the detail of reproduction in the pick up system;

FIG. 23 is another ray diagram showing the detail of reproduction in the pick up system;

FIG. 24 is a plan view of a surface which is in contact with a transparent base plate 2 in a quarter-wave plate 4;

FIG. 25 shows a sectional view (FIG. 25(a)) and a plan view (FIG. 25(b)) of a quarter-wave plate 4 in explaining an example of a method for manufacturing such a quarter-wave plate 4; and

FIG. 26 shows a sectional view (FIG. 26(a)), a plan view (FIG. 26(b)) and a sectional view (FIG. 26(c)) of a quarter-wave plate 4 in explaining another example of a method for manufacturing such a quarter-wave plate 4.

### DESCRIPTION OF THE PREFERRED EMBODIMENT

Referring now to the accompanying drawings, the embodiments of the invention will be described.

First Embodiment

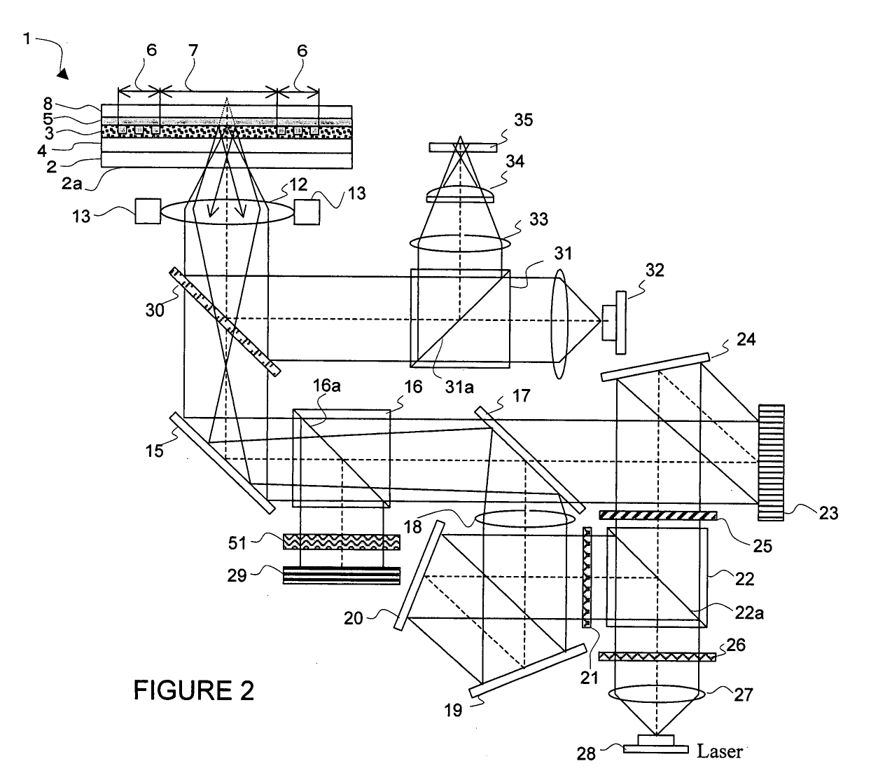

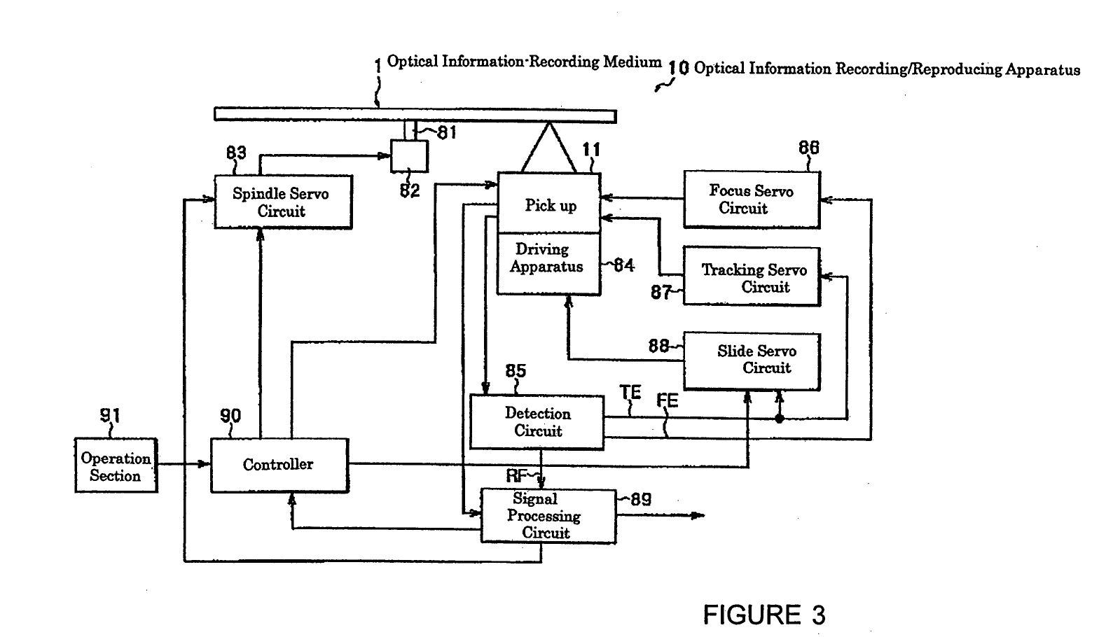

FIG. 2 shows an optical arrangement of a pick up system (hereinafter referred to simply as pick up) according to a first embodiment of the invention, and an optical information-recording medium in an optical information recording/reproducing apparatus according to the first embodiment, and FIG. 3 is a block diagram of the total system in the optical information recording/reproducing apparatus according to the first embodiment. In this case, the optical information recording/reproducing apparatus comprises an optical information recording apparatus and an optical information reproducing apparatus. In the first embodiment, a disk-like optical disk is used as an optical information-recording medium. However, a card-like recording medium may also be used in another embodiment.

the Structure of the Optical Information-Recording Medium

Referring to FIG. 2, the optical information-recording medium according to the first embodiment will be firstly described. The optical information-recording medium 1 is constituted by sequentially laminating a quarter-wave plate (polarization changing layer) 4, a hologram-recording layer 3 as an information-recording layer for recording information utilizing the volume holography, a reflection layer 5 and a substrate (protection layer) 8 on one side of a disk-shaped transparent base plate 2 made of polycarbonate or the like.

The quarter-wave plate 4 is used to transform the light passing therethrough from the linear polarization to the circular polarization, when such a linear polarized light as P-polarized light or S-polarized light impinges on the quarter-wave plate 4, and when the plane of the linear polarization is orientated at 45 degrees with respect to the optical axis of a crystal in the quarter-wave plate 4. The quarter-wave plate 4 is used either to transform the linear polarization to the circular polarization or to transform the circular polarization to the linear polarization. In the first embodiment, a recording reference light used for recording the information in the hologram-recording layer 3 and a reproducing reference light used for reproducing the information from the hologram-recording layer 3 are P-polarized light. In this case, when either the recording reference light or the reproducing reference light (P-polarized light) is incident on the quarter-wave plate 4, the light passing therethrough becomes a circularly polarized light. Furthermore, the circularly polarized light is reflected from the reflection layer 5 in the optical information-recording medium 1 and then returns to the quarter-wave plate 4. In this case, the circularly polarized light changes into the S-polarized light, after the reflected light again passes through the quarter-wave plate 4.

The quarter-wave plate 4 is disposed at a position closer than the hologram-recording layer 3, viewed from the incident side of the reproducing reference light.

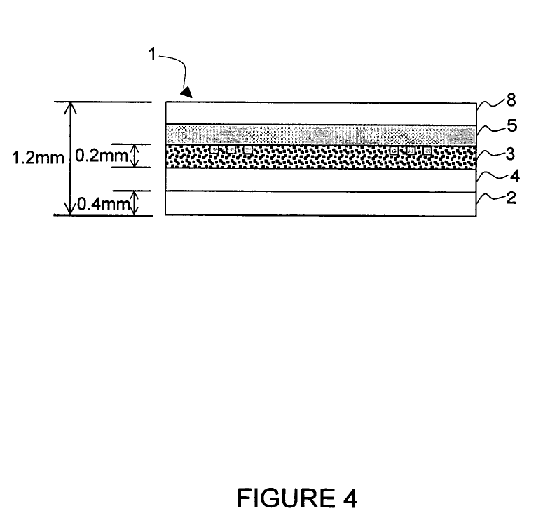

In the first embodiment, as shown in FIG. 4, the transparent base plate 2 has a thickness of, e.g., 0.4 mm, the hologram recoding layer 3 has a thickness of, e.g., 0.2 mm and the optical information-recording medium 1 has a thickness of, e.g., 1.2 mm in total. The thickness of the reflection layer 5 is of order of Angstrom, so that it is negligibly small, compared with the total thickness of the recording medium.

In the first embodiment, as shown in FIG. 4, the optical information-recording medium is constituted so as to have a thickness of 1.2 mm, which is comparable with the thickness of CD or DVD, and therefore the hologram recording medium as the information-recording medium is compatible therewith.

The hologram-recording layer 3 is constituted by a hologram material having optical properties, such as the refractivity, dielectric constant, reflectivity and others, which are changed in response to the intensity of the illuminated light. As a hologram material, photopolymer HRF-600 (product number), Dupont Co. Ltd, can be employed.

The reflection layer 5 is a film used for reflecting light (reproducing reference light or the like). The reflection layer 5 is disposed at a position farther away from the hologram-recording layer 3 and the quarter-wave plate 4, viewed from the incident side of light (reproducing reference light or the like). The reflection layer 5 is produced by, for instance, aluminum.

The substrate (protection layer) 8 is used as an address-including substrate which is produced by means of, for instance, the injection. In the substrate (protection layer) 8, address servo areas 6 in the form of radially extending lines are disposed in a predetermined angular spacing to determine the position, and individual sectors between two adjacent address servo areas 6 are used as data area 7. In the address servo areas 6, information on the execution of the focus servo and tracking servo in the sample-hold mode and the information on the address are recorded in advance by emboss bits or the like (pre-format). In this case, the focus servo may be carried out using the reflection surface of the reflection layer 5, and the wobble bits, for instance, may be used for the information on the execution of the tracking servo.

The Method for Manufacturing the Quarter-Wave Plate 4

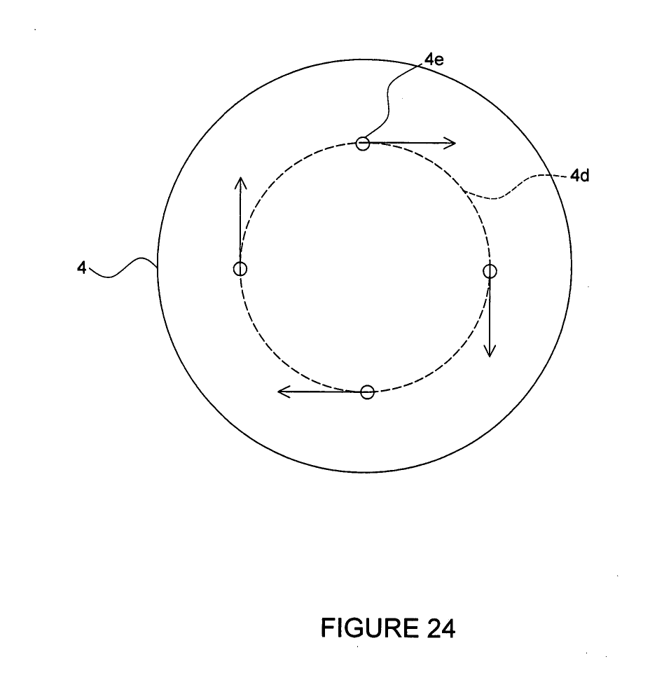

FIG. 24 is a plan view of the quarter-wave plate 4 which is in contact with the transparent base plate 2. The quarter-wave plate 4 is circular, and molecules 4e in a phase difference-generating layer are arranged along a concentric circle 4d in the quarter-wave plate 4. The phase difference-generating layer is used to generate a phase difference in the light, which is incident on the quarter-wave plate 4. The material for the phase difference-generating layer is, for instance, azobenzene. The recording and the reproduction of information are carried out in the state of rotating the optical information-recording medium 1. For an optimal operation of the quarter-wave plate 4, it is essential that the molecules 4e are arranged along the concentric circle 4d in the phase difference-generating layer.

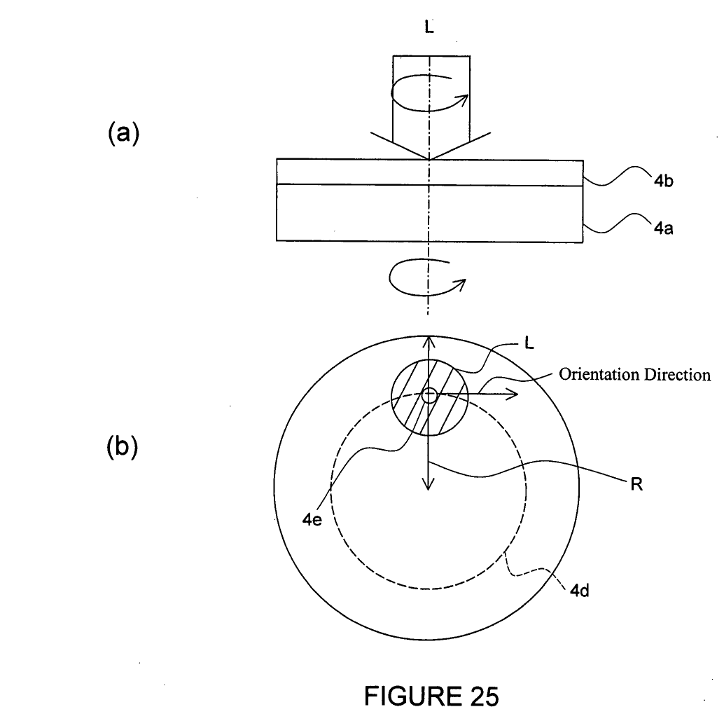

FIG. 25(a) is a front view of a quarter-wave plate 4 and FIG. 25(b) is a plan view thereof, and these drawings are used to exemplarily describe a method for manufacturing the quarter-wave plate 4. The substrate 4a of the quarter-wave plate 4 is a transparent plate. The material for the phase difference-generating layer 4b (for example, azobenzene) is applied to the surface of the substrate 4a. Thereafter, the quarter-wave plate 4 is rotated in the direction indicated by arrows in FIG. 25(a) (the so-called spin coating). The thickness of the phase difference-generating layer 4b is controlled by the speed of revolution. Moreover, a linearly polarized light L, whose vibration plane is aligned in the direction of rotation radius R of the quarter-wave plate 4, impinges on the phase difference-generating layer 4b (see FIG. 25(b)) in the state of rotating the quarter-wave plate 4. A film made of azobenzene has an optical anisotropy, and therefore has a tendency of orientating in the direction perpendicular to the polarization plane of the irradiating polarized light. Consequently, the molecules 4e in the phase difference-generating layer are arranged along the concentric circle 4d, as shown in FIG. 25(b). In the above procedure, the linearly polarized light L is scanned in the direction of the rotation radius R of the quarter-wave plate 4 so as to illuminate the entire surface thereof.

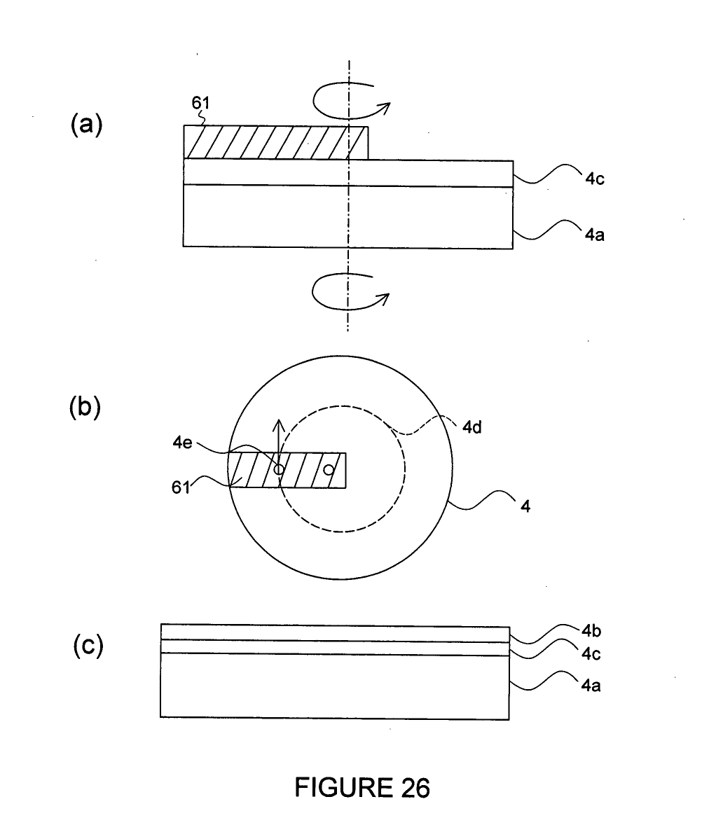

FIG. 26 shows drawings for exemplarily describing another method for manufacturing a quarter-wave plate 4. FIG. 26(a) is a sectional view of the quarter-wave plate 4 in the manufacturing course, and FIG. 26(b) is a plan view thereof. FIG. 26(c) is a sectional view of a finished quarter-wave plate. A polyimide film 4c is firstly formed on the surface of a substrate 4a and then the quarter-wave plate 4 is rotated in the direction of arrows shown in FIG. 26(a). In this case, a piece of cloth 61 made of nylon or the like is placed on the polyimide film 4c, aligning in the direction of the rotation radius (see FIG. 26(b)). In this procedure, very small scratches are generated along the concentric circle 4d, and this procedure is the so-called rubbing. Thereafter, a material for the phase difference-generating layer 4d is applied to the surface of the substrate 4a (polyimide film 4c), and then the spin coating is carried out. Molecules 4e in the phase difference-generating layer are arranged in the fine scratches along the concentric circle 4d.

After the spin coating, the processes, such as drying, UV light irradiation and others, are carried out. Since these processes are well known in the relating technical field, the description thereof is omitted herein.

Moreover, the thickness of the phase difference-generating layer 4b should be preferably 2 to 10 μm.

The Structural Arrangement of an Optical Information Recording/Reproducing Apparatus

Referring now to FIG. 3, the structural arrangement of an optical information recording/reproducing apparatus according to the first embodiment will be described. The optical information recording/reproducing apparatus 10 comprises a spindle 81 onto which an optical information-recording medium 1 is mounted; a spindle motor 82 for rotating the spindle 81; and a spindle servo circuit 83 for controlling the spindle motor 82 so as to maintain the optical information-recording medium 1 in a predetermined number of revolution. Moreover, the optical information recording/reproducing apparatus 10 comprises a pick up 11 for reproducing the information recorded in the optical information-recording medium 1 by irradiating a reproducing reference light onto the optical information-recording medium 1 and then by detecting the reproducing light; and a driving apparatus 84 for guiding the pick up 11 in the radial direction of the optical information-recording medium 1.

Furthermore, the optical information recording/reproducing apparatus 10 comprises a detection circuit 85 for detecting a focus error signal FE, a tracking error signal TE and a reproduction signal RF in response to the output from the pick up 11; a focus servo circuit 86 for moving the objective in the thickness direction of the optical information-recording medium 1 for the focusing by driving an actuator in the pick up 11, based on the focusing error signal FE detected by the detection circuit 85; a tracking servo circuit 87 for moving the objective in the radial direction of the optical information-recording medium 1 to carry out the tracking by driving the actuator in the pick up 11, based on the tracking error signal TE detected by the detection circuit 85; and a slide servo circuit 88 for moving the pick up 11 in the radial direction of the optical information-recording medium 1 to carry out the slide servo by controlling the driving unit 84, based on both the tracking error signal TE and an instruction command from a controller, which will be later described.

Furthermore, the optical information recording/reproducing apparatus 10 comprises a signal processing circuit 89 for decoding the data output from a CMOS or CCD array in the pick up 11 (which will be later described) to reproduce the data stored in a data area 7 of the optical information-recording medium 1 and/or for reproducing the basic clock on the basis of a reproducing signal RF from the detection circuit 85 to identify an address; a controller 90 for controlling the entire system of the optical information recording/reproducing apparatus 10; and an operation unit 91 for supplying various instructions to the controller 90. The controller 90 receives the basic clock from the signal processing circuit 89 and/or address information to control the pick up 11, the spindle servo circuit 83 and the slide servo circuit 88 and others. The spindle servo circuit 83 receives the basic clock output from the signal processing circuit 89. The controller 90 includes a CPU (central processing unit), a ROM (read only memory) and a RAM (random access memory), in which case, the CPU executes the program stored in the ROM, using the RAM as a working area, in order to realize the function of the controller 90.

Referring now to FIG. 2, the function of the pick up 11 according to the first embodiment will be described. The pick up 11 comprises an objective 12 facing the transparent base plate 2 of the optical information-recording medium 1, when the optical information-recording medium 1 is mounted onto the spindle 81; an actuator 13 enabling the objective 12 to be moved in the thickness direction of the optical information-recording medium 1 as well as in the radial direction thereof; a mirror 15; and a polarization beam splitter (PBS) 16.

Moreover, the pick up 11 is equipped with a CCD or CMOS sensor (detection unit) 29 for detecting the reproducing light returned from the polarization splitting plate 16a of the polarization beam splitter 16 on the side (the lower side of PBS 16) where the return light (reproducing light) is reflected therefrom. In this case, a polarizer plate (noise suppressing unit) 51 for passing only the S-polarized light is interposed between the CCD or CMOS sensor 29 and the polarization beam splitter 16. Namely, the polarizer plate 51 serves to transmit only the linearly polarized light having the same vibration direction as the light (S-polarized light) emerged after the circularly polarized light passes through the quarter-wave plate 4.

Moreover, a semi-transparent mirror 17 is disposed on one side of the polarized-light separating plane 16a (right hand side of the PBS) on which the reference light or information light impinges. Furthermore, reference light generating unit comprising a convex lens 18 for defocusing, mirrors 19 and 20, and a half-wave plate 21 is disposed in the incident direction of the light reflected from the semi-transparent mirror 17 (on the lower side of the semi-transparent mirror 17). The half-wave plate 21 is disposed to coincide the polarizing direction of the reference light with the polarizing direction of the information light, which will be later described. The convex lens 18 for defocusing produces reference light which is incident on the objective 12 in the form of a divergent beam by converting a parallel light beam into a divergent light.

The pick up 11 is equipped with a polarization beam splitter 22 in the incident direction of light on the half-wave plate 21 (on the right hand side of the half-wave plate 21). In addition, a spatial light modulator 23, a mirror 24 and an optical shutter 25 are disposed in the incident direction of the light penetrating the semi-transparent mirror 17 (on the right hand side of the semi-transparent mirror 17). The spatial light modulator 23 has a plurality of pixels arranged in a lattice-shape to spatially modulate the light intensity by selecting the state of transmission/interception of the light in each of the pixels, thereby enabling the information light carrying the information to be generated. The spatial light modulator 23 is used as information light generating unit according to the present invention. As a spatial light modulator, for example, a DMD or liquid crystal can be employed.

In the pick up 11, moreover, a half-wave plate 26 is disposed on the side of the incident surface for the beam splitter 22 (on the lower side of the PBS 22), and further a collimator lens 27 and a light source 28 are disposed in this order from the incident surface. In this case, the intensity ratio of the information light to the recording reference light, where these lights are incident on the optical information-recording medium 1 may be optimally adjusted by appropriately changing the inclination angle of the half-wave plate 26. Moreover, the light source 28 is used to emit a linearly polarized light having a high coherency and can be produced by, for instance, a semiconductor laser.

In the pick up 11, moreover, the light from a light source 32 for servo is used to irradiate the optical information-recording medium, and then the light returned therefrom arrives at a quarter divided photo-detector 35 via the objective 12, a dichroic mirror 30, a polarization beam splitter (a semi-transparent mirror can also be employed) 31, a convex lens 33 and a cylindrical lens 34.

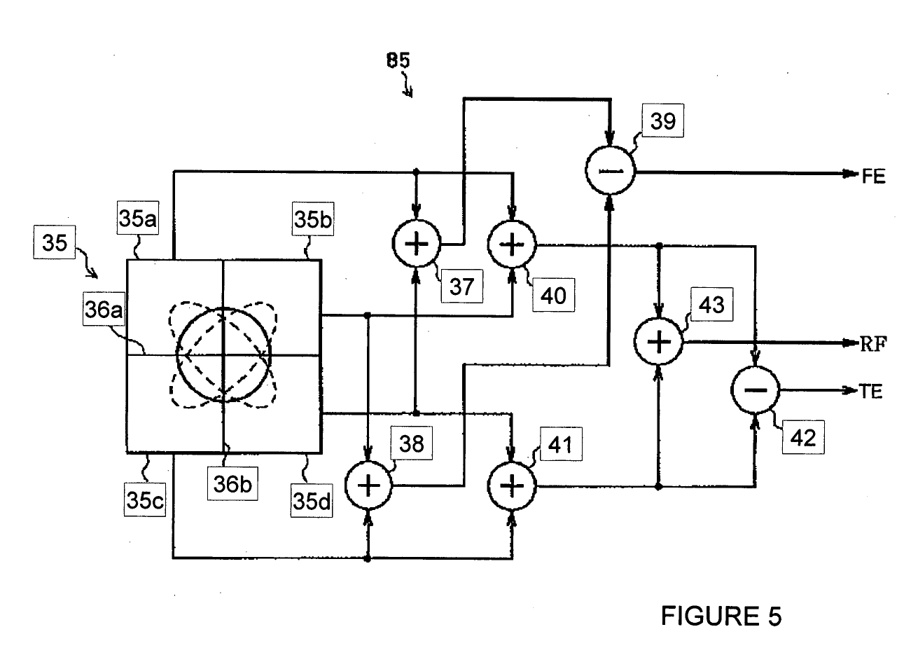

The quarter divided photo-detector 35 has four light-receiving areas 35a to 35d, which are formed by dividing the optical information-recording medium 1 by a dividing line 36a parallel to the track direction and by another dividing line 36b perpendicular thereto, as shown in FIG. 5. A cylindrical lens 34 is disposed such that the center axis of the cylinder surface thereof is inclined at 45° with respect to the dividing lines 36a and 36b for the quarter divided photo-detector 35.

FIG. 5 shows a block diagram of the detector circuit 85 for sensing the focus error signal FE, tacking error signal TE and reproducing signal RF based on the output from the quarter divided photo-detector 35. The detector circuit 85 includes a first adder 37 for adding the output from the light-receiving diagonal section 35a to that from the light-receiving diagonal section 35d in the quarter divided photo-detector 35; a second adder 38 for adding the outputs from the light-receiving section 35b to that from the light-receiving section 35c in the quarter divided photo-detector 35; a first subtracter 39 for determining a difference between the output from the first adder 37 and the output from the second adder 38 to generate the focus error signal FE on the basis of the astigmatic aberration method; a third adder 40 for adding the outputs from the light-receiving sections 35a and 35b in the quarter divided photo-detector 35, where these sections are adjacent to each other in the track direction; a fourth adder 41 for adding the outputs from the light-receiving sections 35c and 35d in the quarter divided photo-detector 35, where these sections are adjacent to each other in the track direction; a second subtracter 42 for determining a difference between the output from the third adder 40 and the output from the fourth adder 41 to generate the tracking error signal TE on the basis of the astigmatic aberration method; and a fifth adder 43 for adding the output from the third adder 40 and the output from the fourth adder 41 to generate the reproducing signal RF. In the first embodiment, the reproducing signal RF is a signal, which is reproduced from information stored in an address servo area 6 inside the optical information-recording medium 1.

In this case, the spatial light modulator 23 and the light sources 28, 32 in the pick up 11 are all controlled by the controller 90 shown in FIG. 3.

In the pick up 11 according to the invention, either a phase spatial modulator can be interposed between the convex lens 18 for defocusing and the mirror 19 or a reflection-type phase spatial modulator can be disposed in the same position as that in the mirror 19 or 20, replacing the mirror therewith, although these are not shown. In this case, the phase spatial modulator includes a plurality of pixels arranged in the form of a lattice and is capable of spatially modulating the optical phase by selecting the phase of light incident on each pixel. Such a phase spatial light modulator may be produced either by a liquid crystal element or by a micro-mirror device in which a micro-mirror may be moved in the direction parallel to the optical axis of the light leaving the device. The phase spatial modulator is also controlled by the controller 90 shown in FIG. 3. The controller 90 includes information on a plurality of modulation patterns for spatially modulating the phase of light in the phase spatial modulator. The operation section 91 is designed such that an appropriate modulation pattern can be selected from the modulation patterns stored therein. The controller 90 supplies the information on either a modulation pattern automatically selected in accordance with predetermined conditions or a modulation pattern selected by the operation section 91 to the phase spatial modulator. In conjunction with this, the phase spatial modulator spatially modulates the phase of light with a corresponding modulation pattern in accordance with the information on the modulation pattern provided by the controller 90.

Moreover, in the pick up 11 according to the invention, the optical system is designed such that the length of the ray path from the polarization beam splitter 22 from the semi-transparent mirror 17 via the mirror 24 and the spatial light modulator 23 is the same as the length of the ray path from the beam splitter 22 to the semi-transparent mirror 17 via the mirrors 20, 19, and the convex lens 18 for defocusing. Such a structural arrangement ensures that the path length of the recording reference light is the same as that of the light from an object, and further provides an advantage that the contrast of the interference fringes may be used in a highest efficiency even if the coherent distance (coherency) of the laser for the hologram recording light source is small.

In the following, the function of the optical information recording/reproducing apparatus according to the first embodiment will be described in the sequence of the servo, recording and reproducing operation modes. The optical information-recording medium 1 is rotated by the spindle motor 82 in such a manner that it always maintains a rated number of revolution in any case of the servo, recording and reproducing operation modes.

Servo Operation Mode

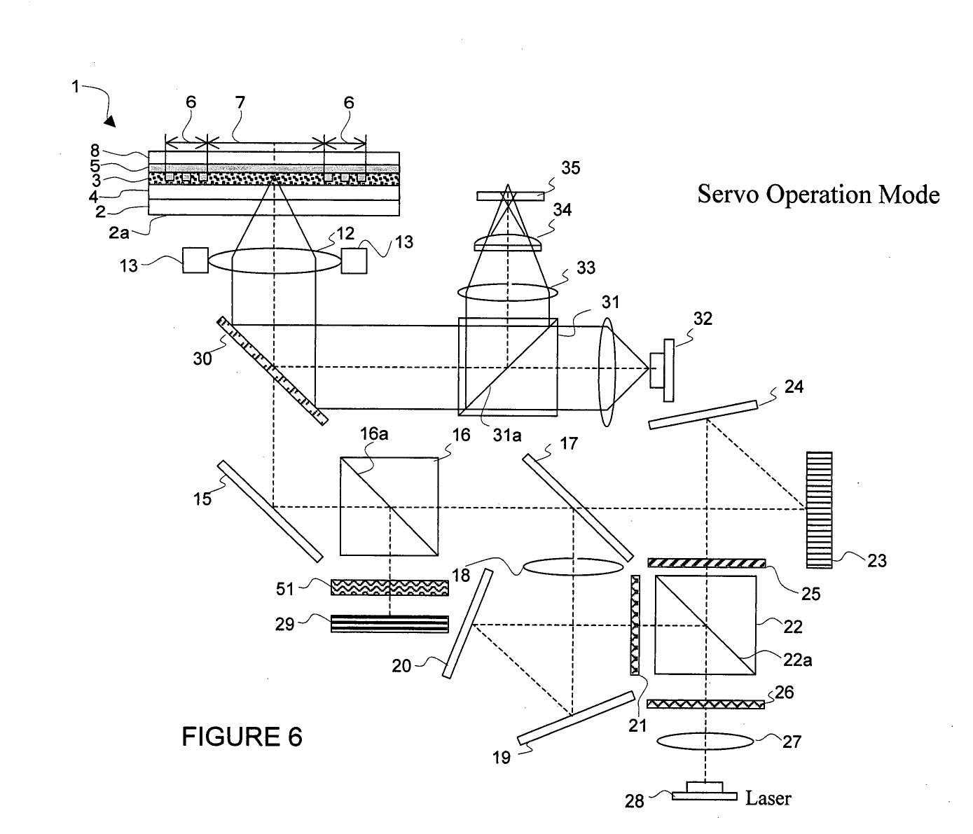

Referring to FIG. 6, the function of the optical information recording/reproducing apparatus in the servo operation mode will be described. In the servo operation mode, the light source 32 for servo is used. The intensity of light emitted from the light source 32 for servo is set at a low power for reproduction. In this case, the controller 90 predicts the period during which the light leaving the objective 12 passes through the address servo area 6, based on the basic clock reproduced from the reproducing signal RF, and maintains the setting of the above-mentioned power during the period during which the light leaving the objective 12 passes through the address servo area 6.

The P-polarized light emitted from the light source 32 for servo is incident on the polarization beam splitter 31, after collimated by the collimating lens 31, and then passes through the polarized light splitting plane 31a, and is further reflected from the dichroic mirror 30 in the form of a parallel light beam. The light reflected from the dichroic mirror 30 (the P-polarized light) impinges on the optical information-recording medium 1 in such a way that it is converged on the reflection layer 5 in the optical information-recording medium 1 by the objective 12. In this case, the light is modulated by emboss pits in the address servo area 6, and then is returned toward the objective 12. Moreover, the light is converted to a circularly polarized light by the quarter-wave plate 4, before converging on the reflection layer 5.

The light returned from the reflection layer 5 (the circularly polarized light) is converted to the S-polarized light after its polarization direction is changed by the quarter-wave plate 4, and then collimated by the objective 12. The S-polarized light thus returned proceeds toward the polarization beam splitter after reflected from the dichroic mirror 30. The dichroic mirror 30 is designed such that the light having a wavelength of, e.g., λ=655 nm is reflected and the light having a wavelength of λ=532 nm or less penetrates the mirror in a transparency of 100%. Accordingly, a red light laser having a wavelength of 655 nm can be employed as the light source 32 for servo and a green light laser light having a wavelength of, e.g., 532 nm, a green purple light laser having a wavelength of 405 nm, or another laser such as a blue light laser can be employed as a light source 28.

The light reflected from the dichroic mirror is a S-polarized light. Accordingly, the light is incident on the polarization beam splitter in the form of a parallel light, and then reflected from the polarization splitting plane 31a, and then further impinges on the convex lens 33. The light incident on the convex lens 33 is converted into a convergent light beam and detected by the quarter divided photo-detector 35 after passing through the cylindrical lens 34. Upon the basis of output from the quartered photo-detector 35, the focus error signal FE, tracking error signal TE and reproducing signal RF are generated by the detection circuit 85 shown in FIG. 5. In accordance with these signals, the focus servo and tracking servo are carried out, along with the reproduction of the basic clock and the identification of the address.

In the above-described servo operation mode, the structural arrangement of the pick up 11 is the same as that of the pick up for recording and reproduction, which is used for a conventional optical disk such as CD (compact disk), DVD (digital video disk or digital versatile disk), HS (hyper storage disk) or the like. Accordingly, it is possible to design the optical information recording/reproducing apparatus 10 according to the invention such that it is compatible with such a conventional optical disk apparatus.

Recording Operation Mode

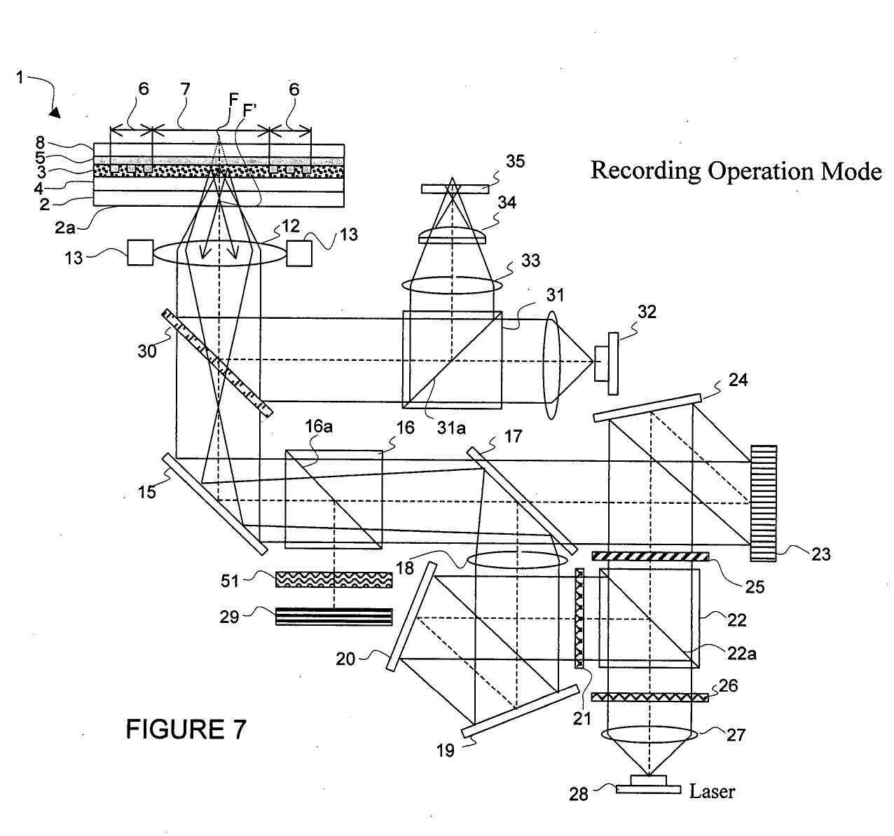

In the following, the function of the optical information recording/reproducing apparatus in the recording operation mode will be described. FIG. 7 shows the structural arrangement of the pick up 11 in the recording operation mode.

The intensity of light emitted from the light source 28 is set at a high power for pulse recording. In this case, the controller 90 predicts the period during which the light leaving the objective 12 passes through the data area 7, based on the basic clock reproduced from the reproducing signal RF, and thereby maintains the setting of the above power during the period where the light leaving the objective 12 passes through the data area 7. The focus servo and the tacking servo are maintained in the state of the light passing through the servo area 7 during the period where the light leaving the objective 12 passes through the data area 7, so that the objective 12 is fixed. In the following description, it is assumed that the light source 28 emits a P-polarized light toward the polarization beam splitter 22.

In FIG. 7, the P-polarized light emitted from the light source 28 is collimated by the collimator lens 27 and then the polarization direction of the light is changed by the half-wave plate (for instance, +22.5 degrees) 26, thereby enabling the light having a P-polarized light component and a S-polarized light component to be generated. The light is incident on the beam splitter 22, in which case, part of light (the P-polarized light component) passes through the polarization splitting plane 22a and the remaining part of light (the S-polarized light component) is reflected from the polarization splitting plane 22a. The reflected light (the S-polarized light component) is incident on the half-wave plate (+45 degrees) 21, where the polarization direction of the S-polarized light is changed by 90 degrees to generate a P-polarized light. The S-polarized light is incident on the convex lens 18 via the mirrors 19 and 20. Thanks to the convex lens, a divergent recording reference light beam at the objective 12 can be generated, as will be later described. The recording reference light thus generated is reflected from the semi-transparent mirror 17.

In the case when a phase spatial light modulator is interposed between the convex lens 18 and the mirror 19, the phase spatial light modulator spatially modulates the phase of light by selectively adding a predetermined phase difference of 0 (rad), π (rad) or a value between them to the light passing therethrough for each pixel in accordance with the predetermined modulation pattern, thereby causing a recording reference light to be generated, in which the phase of the light is spatially modulate. The controller 90 provides the information on the modulation pattern selected either automatically in accordance with a predetermined condition or by the operation section 91 to the phase spatial light modulator. Accordingly, the phase spatial light modulator spatially modulates the phase of the light passing therethrough in accordance with the information on the modulation pattern provided by the controller 90.

On one hand, the P-polarized light penetrating the polarization splitting plane 22a of the beam splitter 22 is reflected from the mirror 24 because the shutter 25 is opened in the recording operation mode, and therefore the reflected light impinges on the spatial light modulator. In the spatial light modulator 23, the reflection state (hereinafter referred to as ON) or the interception state (herein after referred to as OFF) is selected for each pixel in accordance with the information to be stored in the optical information-recording medium 1 to form an information light by spatially modulating the reflected light. In accordance with the embodiment, one bit information is represented by two pixels, where one of the two pixels corresponding to the one bit information is always set ON, and the other is always set OFF. In this case, DMD can be employed as a spatial light modulator.

The information light thus generated (the P-polarized light) penetrates the semi-transparent mirror 17, where the information light as the P-polarized light and the recording reference light as the P-polarized light are again combined with each other (the optical axes thereof are the same). The above-mentioned two types of light behave as the P-polarized light and therefore pass through the polarization beam splitter 16. The information light behaviors as a collimated light beam whereas the recording reference light behaves as a convergent light beam converted by the convex lens for defocusing, and impinges on the polarization beam splitter 16 in the form of a convergent beam. The information light and the recording reference light are both reflected from the mirror 15, thereby causing the proceeding direction of these light beams to be altered.

Since the information light is the light emitted from a green light laser having a wave length of, e.g., 532 nm, as described above, it penetrates the dichroic mirror 30 and then be changed from a collimated light beam to a light beam converging on the reflection layer 5 in the optical information-recording medium 1 by the objective 12.

On the other hand, the recording reference light is once converged in an area between the mirror 15 and the objective 12, and then impinges on the objective 12 in the form of a divergent beam. Since the recording reference light also behaves as the light emitted from, for instance, a green light laser, it penetrates the dichroic mirror 30 and impinges on the objective 12 in the form of a divergent beam, thereby focusing at a point F. In other words, the recording reference light is defocused on the reflection layer 5 in the optical information-recording medium 1, and the light reflected from the reflection layer is focused on a focus point F′ which is conjugate to the focus point F.

In this case, a spatial filter (not shown) is interposed between the mirror 15 and the dichroic mirror 30, so that only the information light of 0 or ±1 order passes through the filter and an extra information light of higher order is rejected from entering the filter. In the first embodiment, the reference light is not modulated by the spatial light modulator and therefore there is no light beam rejected by such a spatial filter. When, however, the reference light is generated by modulating the phase of light with a phase spatial light modulator, higher order light beams are generated in the reference light. Accordingly, only the reference light of 0 or ±1 order penetrates the spatial filter and reference light of higher order is rejected therefrom.

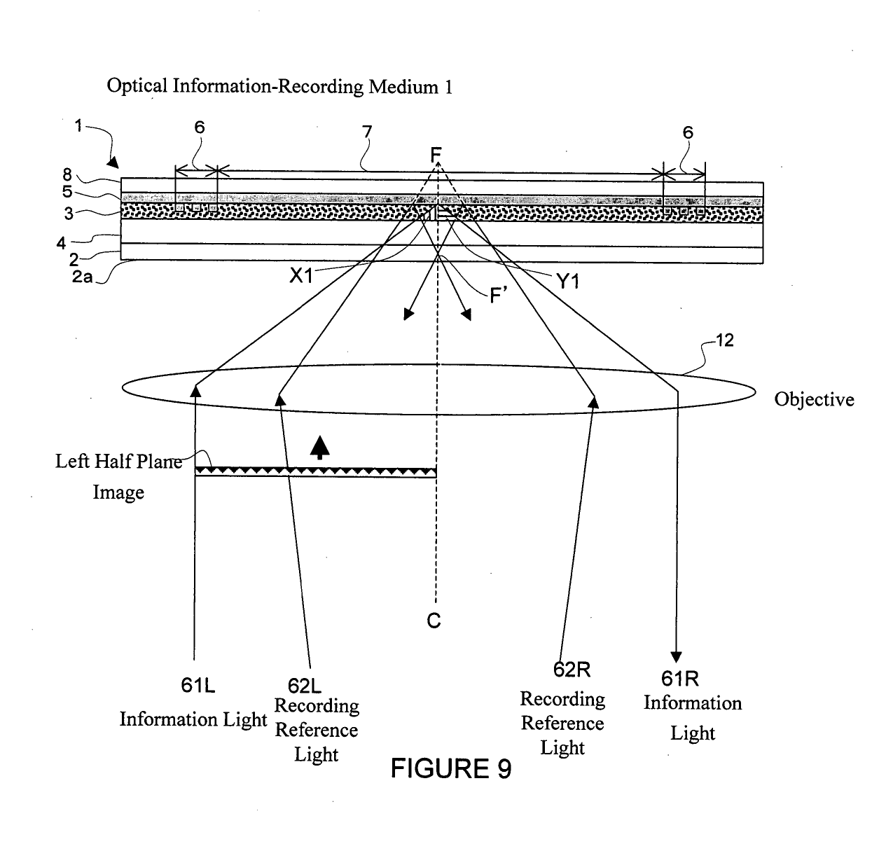

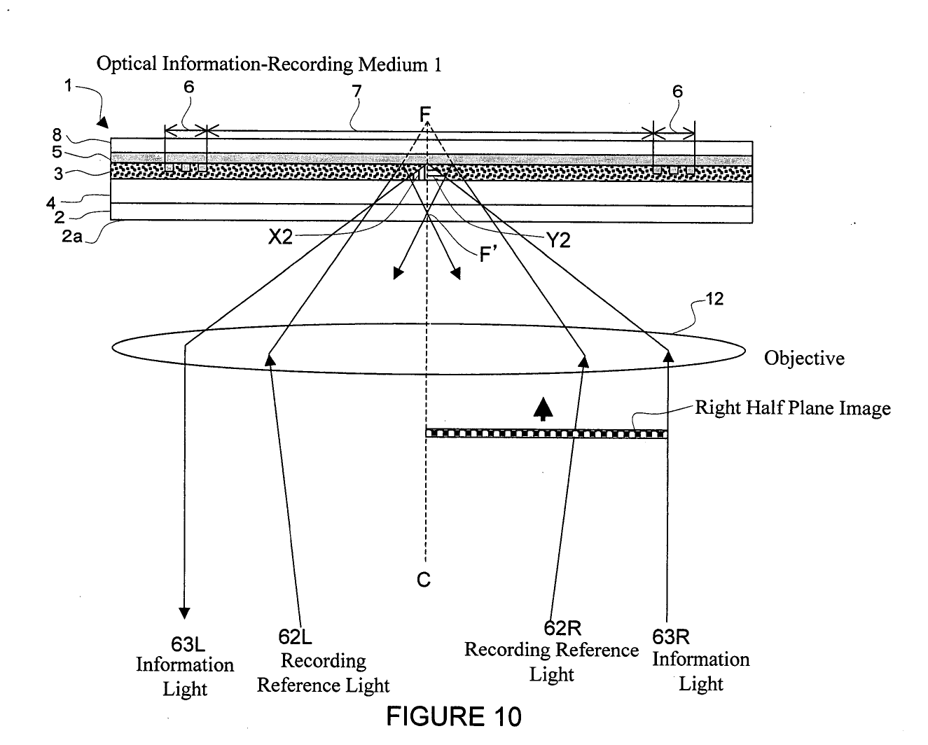

FIGS. 9 and 10 show ray path diagrams in the recording operation mode.

As shown in FIG. 9, information light 61L (the P-polarized light) is incident on the optical information-recording medium 1 via the object 12, and is changed into a circularly polarized light after passing through the quarter-wave plate 4. Moreover, the circularly polarized light penetrates the recording layer 3 and is converged on the reflection layer 5 in a minimum spot size. Thereafter the circularly polarized light is reflected from the reflection layer 5. The reflected light (information light 61R) again penetrates the recording layer 3 in a circularly polarized light, and is then converted from the circularly polarized light to the S-polarized light after passing through the quarter-wave plate 4. Then, the S-polarized light is collimated by the object 12. The information light 61R has information on the page data on the left half plane, as similarly to the information light 61L.

On the other hand, recording reference light 62L as well as recording reference light 62R is also a P-polarized light, and is incident on the optical information medium 1 via the objective lens 12, and further changed into a circularly polarized light after passing through the quarter-wave plate 4. Furthermore, the circularly polarized light beam penetrates the hologram-recording layer 3 and is reflected from the reflection layer 5 in such a way that it is defocused on the reflection layer 5. The actual focus point for the recording reference light is located at F, as shown in FIG. 9, and the light reflected from the reflection layer 5 is converged at F′ which is the conjugate focus point for F. The optical information-recording medium 1 is illuminated by the recording reference light under the condition that the conjugate focus point F′ is located not at the inside of the hologram-recording layer 3, but at a point below the interface between the transparent base plate 2 and the quarter-wave plate 4 (on the side of the objective 12) in FIG. 9. This is due to the fact that if the conjugate focus point F′ is located in the hologram-recording layer 3, the light intensity becomes maximum at the conjugate focus point F′ so that the material of the hologram-recording layer 3 is burnt up and the optical information-recording medium 1 breaks down.

The conjugate focus point F′ can be situated anywhere below the interface between the hologram-recording layer 3 and the quarter-wave plate 4. However, an increase in the departure from the optical information-recording medium 1 provides an increase in the area where the recording reference light penetrates the recording layer 3, so that an extra area other than the portion, at which the interference fringes are generated, are exposed by the reference light. When, therefore, the conjugate focus point F′ is situated in the inside of the transparent base plate 2, the exposure of such an extra area can be suppressed. This arrangement can be employed in a preferable case.

The circularly polarized information light 61L passed through the quarter-wave plate 4 and the circularly polarized recording reference light 62L passed through the quarter-wave plate 4 interfere with each other to form a transmission type interference pattern (vertical fringes) at an area X1, and the interference pattern is three-dimensionally recorded in the area X1 of the hologram-recording layer 3. Moreover, a reflection type interference pattern (horizontal fringes) is also formed in part of the area X1 by the returned light of the recording reference light 62L reflected from the reflection layer 5 and the information light 61L, although these are not shown.

Moreover, the circularly polarized information light 61L passed through the quarter-wave plate 4 and the circularly polarized recording reference light 62R passed through the quarter-wave plate 4 interfere with each other to form a transmission type interference pattern (vertical fringes) in an area Y1, and the interference pattern is three-dimensionally recorded in the area Y1 of the hologram-recording layer 3. Moreover, a reflection type interference pattern (horizontal fringes) is also formed in part of the area Y1 by the returned light of the recording reference light 62R reflected from the reflection layer 5 and the information light 61L.

As shown in FIG. 10, the optical information-recording medium 1 is irradiated by the information light 63R (the P-polarized light) via the objective 12 and a circularly polarized light is produced after the information light 63R passes through the quarter-wave plate 4. Moreover, the circularly polarized light is converged in a minimum spot size on the reflection layer 5 after passing through the recording layer 3 and then reflected from the reflection layer 5. The reflected light (information light 63L) again penetrates the recording layer 3 in the circularly polarized light and further penetrates the quarter-wave plate 4 to change from the circularly polarized light to the S-polarized light. Then, the S-polarized light is collimated by the objective 12. The information light 63L has the information of the page data on the right half plane, as similarly to the information light 63R.

The recording reference light beams 62L and 62R provide the same function as that elucidated, referring to FIG. 9, and therefore the description thereof is omitted.

The circularly polarized information light 63R passed through the quarter-wave plate 4 and the circularly polarized recording reference light 62R interfere with each other to form a transmission type interference pattern (vertical fringes) in an area Y2, and the interference pattern is three-dimensionally recorded in the area Y2 of the hologram-recording layer 3. Moreover, a reflection type interference pattern (horizontal fringes) is also formed in part of the area Y2 by the returned light of the recording reference light 62R reflected from the reflection layer 5 and the information light 63R, although these are not shown.

Furthermore, The circularly polarized information light 63R passed through the quarter-wave plate 4 and the circularly polarized recording reference light 62L interfere with each other to form a transmission type interference pattern (vertical fringes) in an area X2, and the interference pattern is three-dimensionally recorded in the area X2 of the hologram-recording layer 3. Moreover, a reflection type interference pattern (horizontal fringes) is also formed in part of the area X2 by the returned light of the recording reference light 62L reflected from the reflection layer 5 and the information light 63R.

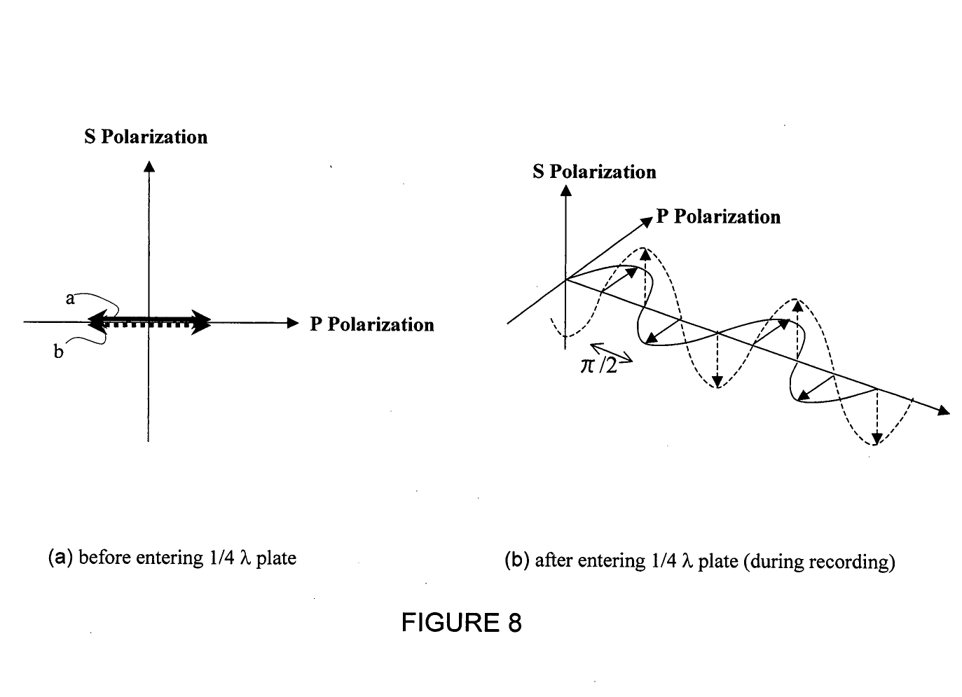

Referring now to FIG. 8, the behavior of light before and after the incidence on the quarter-wave plate 4 will be described. As shown in FIG. 8(a), the information light and recording reference light are both P polarized lights, and are changed into the circularly polarized lights by the quarter-wave plate 4. FIG. 8(b) shows the behavior of the circularly polarized light. From the diagram shown in FIG. 8(b), it can be recognized that a helicoide having a period of one wavelength is provided by the electric field vectors indicated by both the solid line arrow and the broken line arrow. This is the circularly polarized light. In the recording, therefore, the information light and the recording reference light are in the state of circular polarization.

As shown in FIGS. 9 and 10, in the first embodiment, the optical axis of the information light and the optical axis of the recording reference light are positioned on a line, and the hologram-recording layer 3 is illuminated from one side thereof by both the information light and the recording reference light.

In the first embodiment, moreover, it is possible to carry out the multiple recording of the information in a portion of the hologram-recording layer 3 by the phase code multiplexing in which the recording reference light is recorded several times with varied modulation patterns in the portion of the hologram-recording layer 3.

As described above, the transmission type hologram and the reflection type hologram are formed in the same area of the hologram-recording layer 3 according to the first embodiment. However, even when the transmission type hologram (vertical fringes) is formed, it is determined in accordance with the hologram material constituting the hologram-recording layer 3 as to whether or not the reflection type hologram (horizontal fringes) is formed and/or how much the reflection type hologram is formed. Generally, it is difficult to enhance the sensitivity for the hologram material in the reflection type hologram, compared with that in the transmission type hologram. Therefore, if a hologram material having no sensitivity to the reflection type hologram is used, the above-mentioned reflection type hologram (horizontal fringes) is formed neither in part of the area X1, nor in part of the areas Y1, X2 andY2.

In the first embodiment, moreover, the ray path in the optical system for servo and that in the optical system for recording/reproduction are separated from each other, and therefore it is also possible to carry out the focus servo in the recording operation mode.

In the first embodiment, the magnitude of the area (hologram), in which an interference pattern produced by both the information light and the reference light in the hologram-recording layer 3 is three-dimensionally recorded, can be arbitrarily determined by moving the convex lens 16 in the forward/backward direction and/or by altering the magnification thereof.

The Reproducing Operation Mode

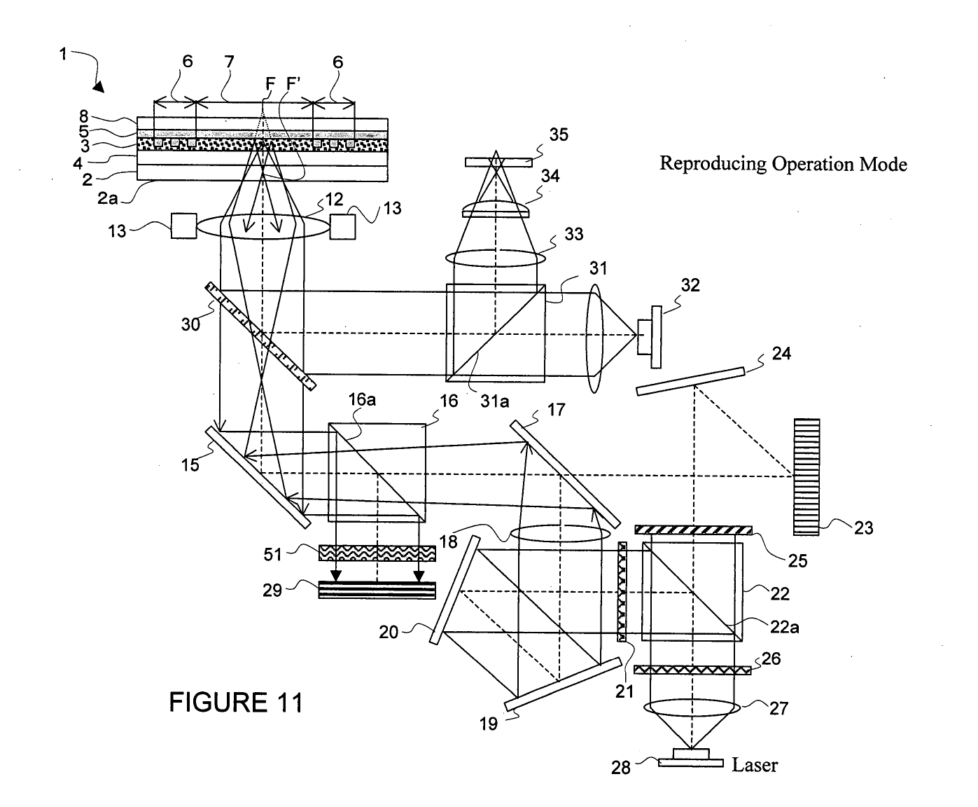

In the following, the function of the optical information recording/reproducing apparatus according to the first embodiment in the reproducing operation mode will be described. FIG. 11 is a diagram showing the operation state of the pick up 11.

In the reproducing operation mode, a shutter 25 interposed between the mirror 24 and the polarization beam splitter 22 is turned on, so that the incidence of light onto the spatial light modulator 23 is forbidden. The light incident on the spatial light modulator 23 can be intercepted by the shutter 25 in the reproducing operation mode. However, all the pixels in the spatial light modulator 23 can also be turned on by way of precaution.

The intensity of the light emitted from the light source 28 is set at a low power for reproduction. In this case, the controller 90 predicts the period where the light passed through the objective 12, based on the basic clock reproduced from the reproducing signal RF, and sets the intensity of the light into the low power during the period where the light passed through the objective 12. In the below description, it is assumed that the light source 28 emits a P-polarized light to the beam splitter 22 in the reproducing operation mode, as similarly to the recoding operation mode.

As shown in FIG. 11, the P-polarized light emitted from the light source 28 is collimated by a collimator lens 27. Then, the polarization direction thereof is changed by the half-wave plate (+22.5 degrees) 26 to form a light beam including a P-wave component and a S-wave component with respect to the beam splitter 20. The light beam is incident on the beam splitter 20 in such that part of the light (the P-polarized light) penetrates the polarization splitting plane 22a and the remaining part of the light (the S-polarized light) is reflected from the polarization splitting plane 22a. The reflected light (S) is incident on the half-wave plate (+45 degrees) 21 where the polarizing direction of the S-polarized light is altered by 90 degrees to generate P-polarized light. The P-polarized light is incident on the convex lens 18 via the mirrors 20 and 19. The reproducing reference light converged at the objective 12 is produced by the convex lens 18. The reproducing reference light thus produced is incident on the polarization beam splitter 16 after reflected by the semi-transparent mirror 17. The reproducing reference light is the same as the recording reference light, which is used in the recording operation mode.

When a phase spatial modulator (not shown) is interposed between the convex lens 18 and the mirror 19 to produce a recording reference light, the controller 90 supplies the information on the modulation pattern for the recording reference light to the phase spatial light modulator in the case of recording the information to be reproduced. The phase spatial light modulator spatially modulates the phase of the transmitting light in accordance with the modulation pattern supplied by the controller 90 to generate the reproducing reference light in which the phase of light is spatially modulated.

The reproducing reference light incident on the polarization beam splitter 16 is a P-polarized light and penetrates the polarization separation plane 16a of the polarization beam splitter 16, and then is reflected by the mirror 15 to alter the proceeding direction of the light beam. The reproducing reference light is once converged between the mirror 15 and the objective 12, and thereafter incident on the objective 12 in the form of a divergent light beam. Since the reproducing reference light is, for instance, light from emitted from a green laser, it penetrates the dichroic mirror 30 and is incident on the objective 12 in the form of a divergent beam, so that it focuses on the point F. In other words, the reproducing reference light is defocused on the reflection layer 5 in the optical information-recording medium 1, and the light thus reflected by the reflection layer is converged on focus point F′ which is conjugate to the focus point F.

In this case, a spatial filter (not shown) is interposed between the mirror 15 and the dichroic mirror 30. When, however, the reproducing reference light is generated by modulating the phase of the light with the phase spatial light modulator in the first embodiment, higher order light are also generated in the reference light. Accordingly, only 0, or +1 order reference light passes through the spatial filter and the higher order light is rejected by the spatial filter.

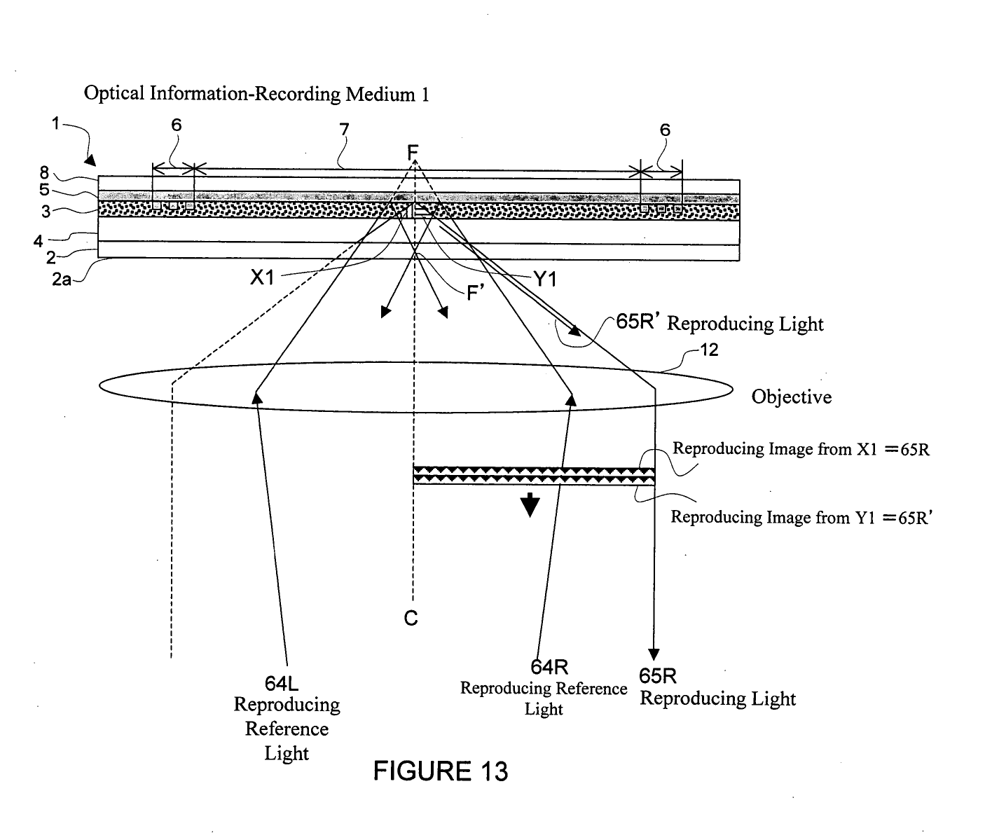

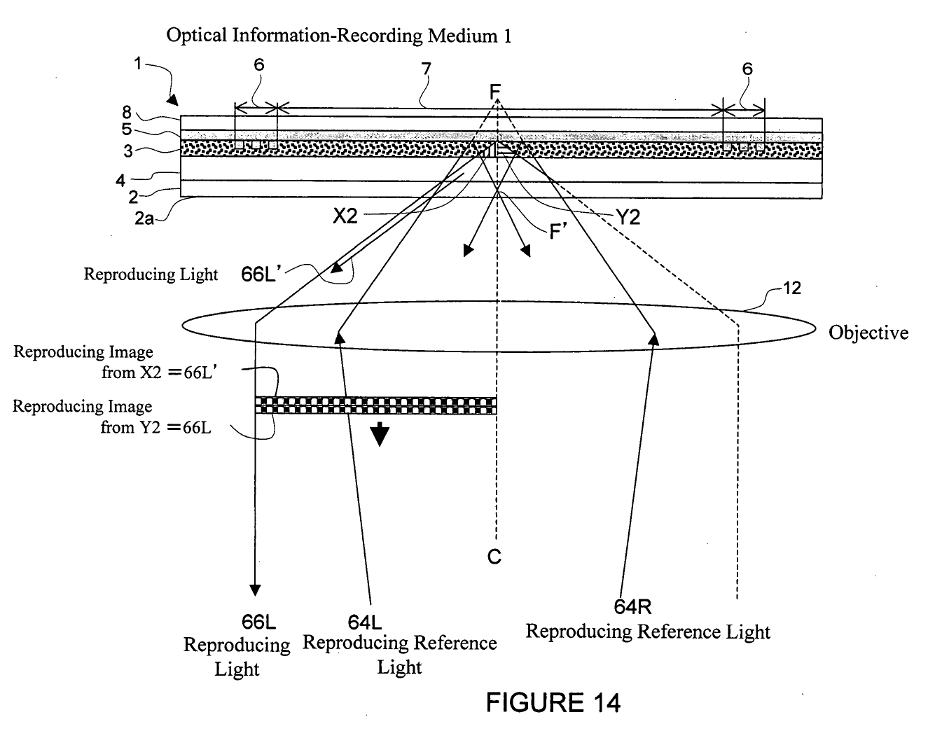

The reproducing light is generated by the irradiation of the reproducing reference light. The reproducing light thus generated is changed from the circularly polarized light to a S-polarized light by the quarter-wave plate 4, and further collimated by the objective 12. The reproducing light penetrates the dichroic mirror 30, and is further incident on the polarization beam splitter 16, after reflected by the mirror 15. Since the reproducing light is a S-polarized light, it is reflected by the polarization separation plane 16a, so that a reproduced image is detected by a CCD or CMOS sensor 29. In this case, stray light generated by optical elements, such as the base plate, objective 12 and/or the like closer to the recording layer 3 on the incident side is a P-polarized light, so that it is intercepted so as not to enter the CCD or CMOS sensor 29 by the polarizer plate 51. The reproduced image thus detected are subject to signal processes, such as the error correction, required decoding and others, and then reproduced in accordance with the data stored in the optical information-recording medium 1. A series of such signal processes is carried out in the signal processing circuit 89 in FIG. 3. FIGS. 13 and 14 show the behavior of light in the reproducing operation mode.

As shown in FIG. 13, the reproducing reference light 64L impinges on the optical information-recording medium 1 via the objective 12, and in changed into a circularly polarized light after passing through the quarter-wave plate 4. Moreover, the circularly polarized light passes through the hologram-recording layer 3 and is reflected by the reflection layer 5, so that it is converged in a minimum spot size at a focus point F′ which is conjugate to the focus point F in the case of no reflection layer 5. The reproducing reference light reflected by the reflection layer 5 again passes through the hologram-recording layer 3. In accordance with such a reproducing reference light, the reproducing light 65R corresponding to the information light 61L (left half plane image on DMD=let half page data) in the record mode is generated from the area X1 of the hologram-recording layer 3. The reproducing light 65R is the light emerged from the vertical fringes generated in X1. The reproducing light 65R thus produced is changed from the circularly polarized light to the S-polarized light after passing through the right hand side of the quarter-wave plate 4.

The reproducing reference light 64R impinges on the optical information medium 1 via the objective 12, and is changed from the P-polarized light to the circularly polarized light, after passing through the right side of the quarter-wave plate 4. Thereafter, the circularly polarized light penetrates the hologram-recording layer 3 and then is reflected by the reflection layer 5 to converge in a minimum spot size at a focus point F′ which is conjugate to the focus point in the case of no reflection layer 5. The reproducing reference light 64R thus reflected by the reflection layer 5 again penetrates the hologram-recording layer 3. In accordance with such illumination of the reproducing reference light, a reproducing light 65R′ corresponding to the information light 61L (left half plane image=left half page data) in the record mode is generated in the area Y1 of the hologram-recording layer 3. The reproducing light 65R′ is the light which is emerged from the horizontal fringes generated in Y1. The reproducing light 65R′ thus generated is changed from the circularly polarized light to the S-polarized light after passing through the right hand side of the quarter-wave plate 4, as similarly to the reproducing light 65R.

The reproducing light 65R and reproducing light 65R′ are the images corresponding to the information light 61L (the left half plane image on DMD), so that they provide no ghost image and can be clearly detected by the CCD or CMOS sensor 29.

On the other hand, as shown in FIG. 14, a reproducing light 66L corresponding to the information light 63R (right half plane image on DMD=right half page data) in the record mode is generated from the area Y2 of the hologram-recording layer 3 in accordance with the illumination of the reproducing reference light 64R. The reproducing light 66L is the light, which is emerged from the vertical fringes generated in Y2. The reproducing light 66L thus generated is changed from the circularly polarized light to the S-polarized light after passing through the left side of the quarter-wave plate 4.

Similarly, a reproducing light 66L′ corresponding to the information light 63R (right half plane image on DMD=right half page data) in the recording operation mode is generated from the area X2 of the hologram-recording layer 3 in accordance with the illumination of the reproducing reference light 64L. The reproducing light 66L′ is the light emerged from the horizontal fringes generated in X2. The reproducing light 66L′ thus generated is also changed from the circularly polarized light to the S-polarized light after passing through the left side of the quarter-wave plate 4, as similarly to the reproducing light 66L.

The reproducing light 66L and reproducing light 66L′ provide an image corresponding to the information light 63R (left half plane image on DMD), so that they provide no ghost image and can be clearly detected by the CCD or CMOS sensor 29.

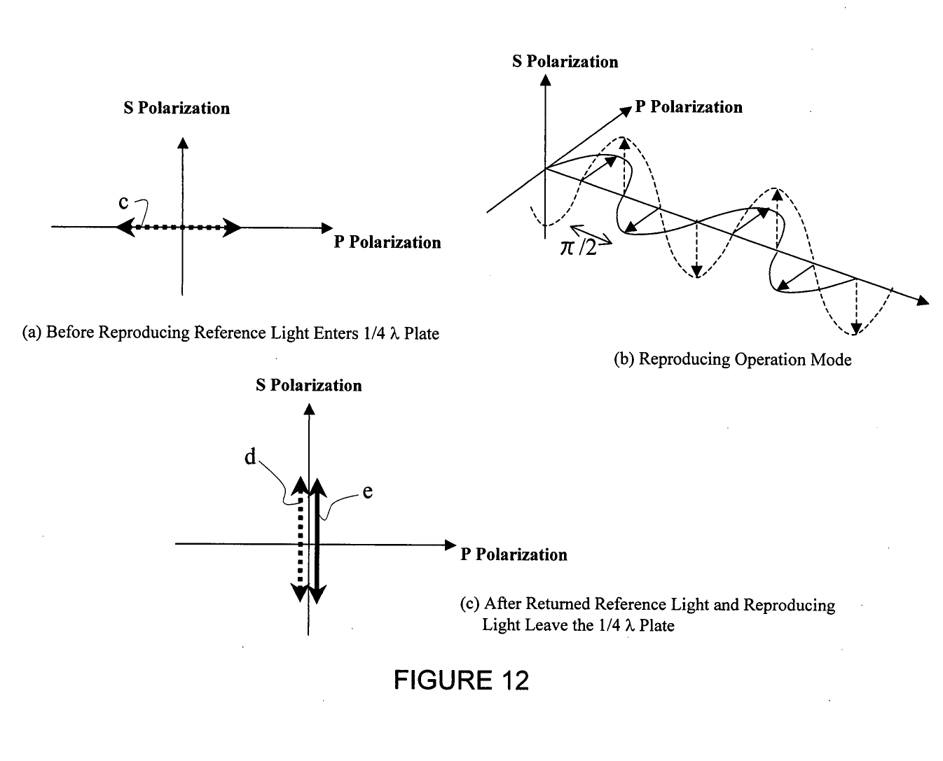

Referring to FIG. 12, the behavior of light before and after the incidence on the quarter-wave plate 4 in the reproducing operation mode will be described. As shown in FIG. 12(a), the reproducing reference light is a P-polarized light and it is converted to the circularly polarized light by the quarter-wave plate 4. FIG. 12(b) shows the behavior of the circularly polarized light. From the diagram shown in FIG. 12(b), it can be recognized that the electric field vectors indicated by the solid line arrow and the broken line arrow provide a helicoide having a period of one wavelength. This is the circularly polarized light. Accordingly, the reproducing reference light behaves as a circularly polarized light in the reproducing operation mode.

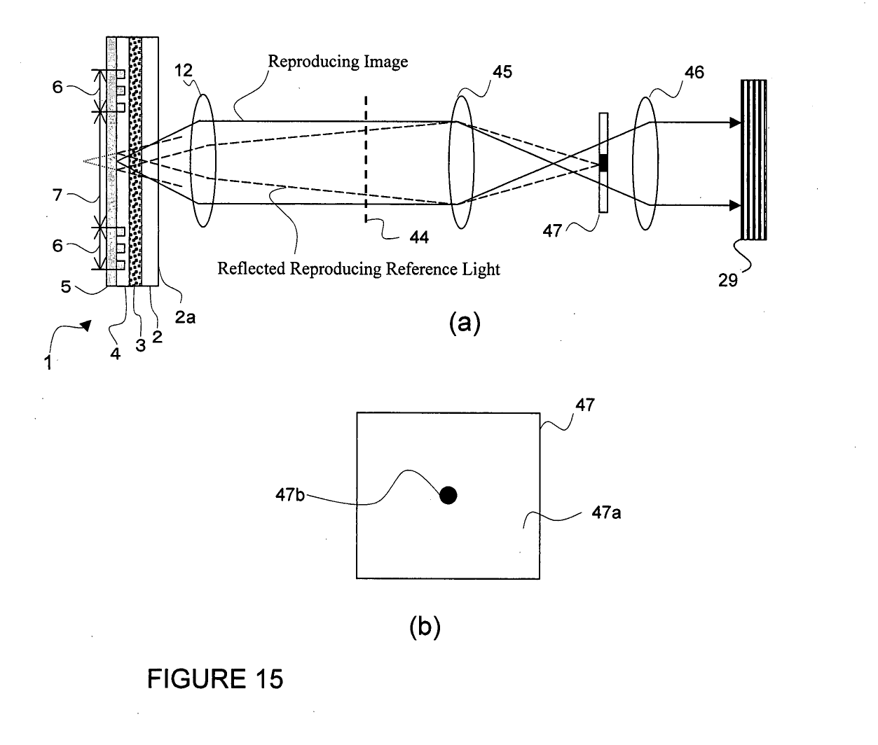

In the first embodiment, the polarization of the reproducing reference light and the polarization of the reproducing light are the S polarization after passing through the quarter-wave plate 4. As a result, the reproducing reference light is also detected by the CCD or CMOS sensor 29, and therefore prevents the reproducing image from detecting. In view of this fact, the reference light is spatially separated, using a mask, as shown in FIG. 15.

FIG. 15 shows the schematic view of the optical elements arranged from the optical information-recording medium 1 to the CCD or CMOS sensor 29. In FIG. 15, the same reference numerals are used for the same functional elements. In FIG. 15, the convex lenses 45 and 46 can be regarded as a relay optics which is used to focus a reconstructed image on the CMOS sensor 29. In this case, an image plane 44 for the reconstructed image exists between the objective 12 and the convex lens 45.

As shown in FIG. 15, the reproducing reference light reflected from the optical information-recording medium 1 and the reproducing light generated therein provide focusing points different from each other. In view of the imaging properties, the reference light can be rejected by disposing a shield mask 47 at the focus point for the reproducing reference light thus reflected. The diameter of a beam stopping layer 47b at the center of the shield mask 47 is substantially the same as the diameter of the reproducing reference light beam and is very small. In addition, the beam stopping layer 47b is positioned farther away from the plane of the reconstructed image. As a result, the beam stopping layer 47b provides no influence on the imaging of the reproducing light on the CMOS sensor 29. The deposition of the shield mask 47 allows the reproducing reference light to be effectively rejected.

In the first embodiment, it can be designed that the polarization of the light incident on the quarter-wave light 4 is perpendicular to the polarization of the light emerged therefrom and that almost all pieces of reproducing light produced from the polarization beam splitter 16 is detected, and therefore a high efficiency in the optical utilization as well as an advantage in the optics can be obtained. Furthermore, this arrangement is particularly useful for rejecting the surface reflection and the undesirable stray light generated in optical elements, such as base plate 2, objective 12 or the like, which are closer to the recording layer 3 on the side of laser source 28.

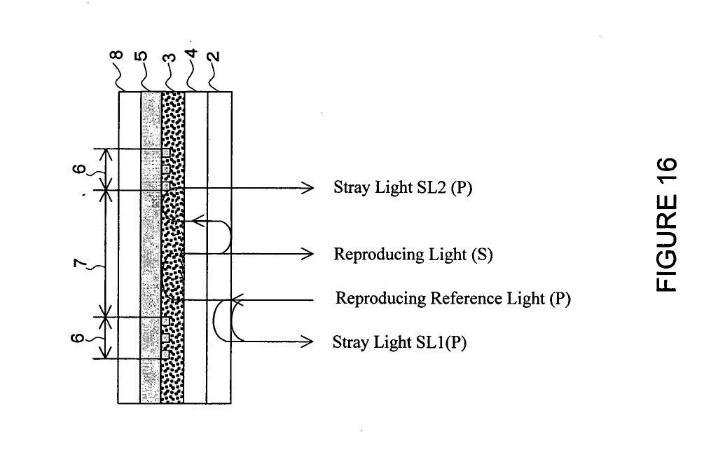

Referring to FIG. 16, the rejection of stray light will be described. FIG. 16 shows the polarization state of the stray light and the reproducing light, when irradiating the reproducing reference lights 64L, 64R to the optical information-recording medium. As a matter of convenience, it is assumed in FIG. 16 that the reproducing reference light is incident on the optical information-recording medium 1 in the direction perpendicular thereto and the reproducing light leaves the optical information-recording medium 1 in the direction perpendicular thereto.

In FIG. 16, the reproducing reference light (P-polarized light) is incident on the optical information-recording medium 1. Part of the light is reflected on the surface of the base plate 2 or in the inside thereof to produce stray light SL1. The stray light SL1 is a P-polarized light. On the other hand, the reproducing reference light passed through the base plate 2 becomes a circularly polarized light after passing through the quarter-wave plate 4. Then, the circularly polarized light enters the hologram-recording layer 3, so that a reproducing light is generated therein and further penetrated the quarter-wave plate 4 to form a S-polarized light. The reproducing light (S-polarized light) passes through the base plate 2 and leaves the optical information-recording medium 1. In this case, part of the reproducing light (S-polarized light) is reflected on the interface (the incident surface for the light) between the base plate 2 and the exterior, and then leaves the optical information-recording medium 1 after sequentially passing through the quarter-wave plate 4, the hologram-recording layer 3, the quarter-wave plate 4 and the base plate 2. Such light going and returning in the inside of the optical information-recording medium 1 also becomes stray light SL2. Such stray light is the P-polarized light. As described above, the reproducing light is the S-polarized light, whereas the stray light SL1 as well as SL2 is the P-polarized light. The objective 12 is an optical element other than the base plate 2, which element is located closer to the recording layer 3 on the incident side. The reproducing reference light reflected from the objective 12 is also stray light and the P-polarized light.

Such stray light generated at optical elements, such as the base plate 2, objective 12 and others which are located closer to the recording layer 3 on the incident side is the P-polarized light, and therefore it is isolated from the CCD or CMOS sensor 29 by the polarizer plate 51 through which only the S-polarized light passes. On the other hand, the reproducing light is the S-polarized light and therefore penetrates the polarizer plate 51, so that it arrives at the CCD or CMOS sensor 29. Accordingly, the deterioration of S/N ratio resulting from the stray light can be suppressed.

When several pieces of information are multiple-recorded in the hologram layer 3 by varying the modulation pattern for the recording reference light, only a piece among the pieces of information, which piece corresponds to the recording reference light having the same modulation pattern as that in the reproducing reference light, is reproduced.

In the first embodiment, the irradiation of the reproducing reference light and the collection of the reproducing light are carried out on the same surface side of the hologram-recording layer 3 such a way that the optical axis of the reproducing reference light and the optical axis of the reproducing light are positioned on the same line.

In the first embodiment, moreover, an interference pattern with the recording reference light is formed in the form of a collimated light beam in the hologram-recording layer 3 by irradiating the objective 12 with the information light, so that the reproducing light generated also leaves the objective 12 in the form of a collimated light beam, thereby enabling the reproduction image to be detected by the CCD or CMOS sensor 29 in the form of a parallel light beam.

In the first embodiment, the stray light (P-polarized light) generating from optical elements (substrate 2, objective lens 12 and others) located closer to the hologram-recording layer 3 on the incident side for the reproducing reference light has a vibrating direction different from that in the reproducing light (S-polarized light) leaving the optical information-recording medium 1, where the reproducing light is generated from the hologram-recording layer 3 after the reproducing reference light impinges thereon. As a result, the stray light and reproducing light can be separated from each other, thereby making it possible to suppress the reduction of the S/N ration resulting from the stray light component.

Since the hologram-recording layer 3 is in contact with the reflection layer 5, there are no optical elements situated far away from the hologram-recording layer 3 on the incident side for the reproducing reference light and therefore there is no origin of generating the stray light, thereby making it possible to reduce the intensity of the stray light component.

Second Embodiment

The optical information recording/reproducing apparatus according to the second embodiment is different from the apparatus according to the first embodiment with regard to the structure of the optical information-recording medium. The same reference numeral is attached to the same functional element as that in the first embodiment and any further description thereof is not given.

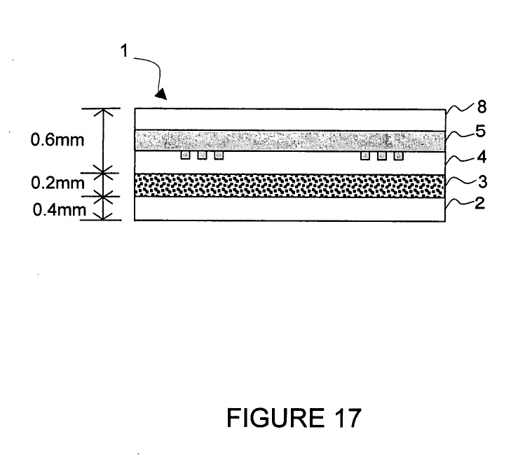

FIG. 17 is a sectional view of an optical information-recording medium according to the second embodiment. The optical information-recording medium 1 is constituted by sequentially laminating a hologram-recording layer 3 as an information-recording layer for recording information using the holography, a quarter-wave plate 4, a reflection layer 5 and a substrate (protection layer) 8 on one side of a disk-shaped transparent base plate 2 made of polycarbonate or the like.

The difference from the first embodiment is that the quarter-wave plate 4 is disposed far away from the hologram-recording layer 3 viewed from the incident side of the reproducing reference light and that the quarter-wave plate 4 is in contact with the reflection layer 5.

In the second embodiment, for instance, the transparent base plate 2 has a 0.4 mm thickness; the hologram-recording layer 3 has a 0.2 mm thickness; the quarter-wave plate 4, the reflection layer 5 and the substrate (protection layer) 8 have a 0.6 mm thickness. In this case, the thickness of the reflection layer 5 is of order of Angstrom and therefore negligibly small, compared with the thickness of the entire thickness of the recording medium.

The method for manufacturing the quarter-wave plate 4 and the structural arrangement of the optical information recording/reproducing apparatus in the second embodiment are the same as those in the first embodiment.

The function of the optical information recording/reproducing apparatus according to the second invention will be described as for the servo operation mode, recording operation mode and the reproducing operation mode, in this order. The optical information-recording medium 1 is rotated by a spindle motor 82 so as to maintain a predetermined number of revolution in any of the servo, recording and reproducing operation modes.

The function in the servo operation mode according to the second embodiment is the same as that according to the first embodiment, and therefore the description thereof is omitted.

The Recording Operation Mode

The optical feature in the second embodiment till the information light and the recording reference light pass through the objective 12 is the same as that in the first embodiment (see FIG. 7).

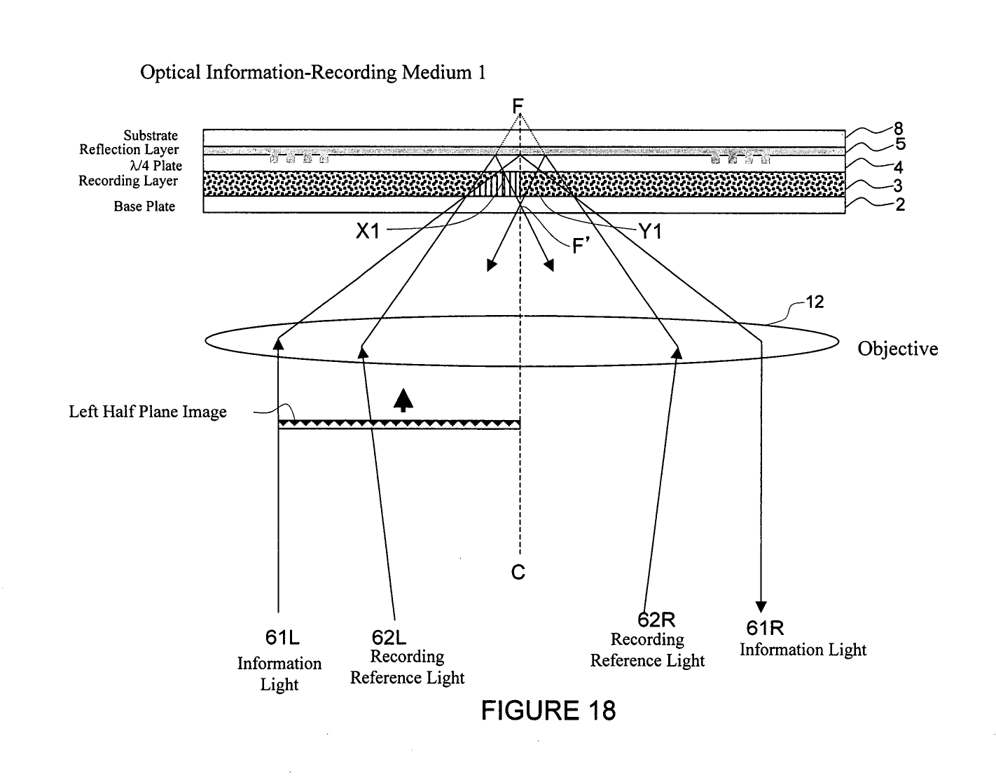

FIGS. 18 to 21 show the ray diagrams in the recording operation mode.

As shown in FIG. 18, information light 61L (P-polarized light) impinges on the optical information-recording medium 1 via the objective 12 and then passes through the hologram-recording layer 3 and the quarter-wave plate 4 to change into the circularly polarized light. Moreover, the circularly polarized light is reflected from the reflection layer 5 so as to be converged in a minimum spot size on the reflection layer 5. The reflected light (information light 61R) again penetrates the quarter-wave plate 4 in the circularly polarized state to change from the circularly polarized light to the S-polarized light. Thereafter, the S-polarized light passes through the hologram-recording layer 3 and then is collimated by the objective 12. The information light 61R has the left half information on the page data, as similarly to the information light 61L.

On the other hand, the recording reference light 62L and the recording reference light 62R are also P-polarized light, and impinge on the optical information-recording medium 1 via the objective 12 and pass through the hologram-recording layer 3 and the quarter-wave plate 4 to change into circularly polarized lights. Moreover, the circularly polarized lights are reflected from the reflection layer 5 so as to defocus on the reflection layer 5. These lights thus reflected again penetrate the quarter-wave plate 4 in the circularly polarized state to change from the circularly polarized light to the S-polarized light. The focus point of these recording reference lights is F indicated in FIG. 18 and the lights reflected from the reflection layer 5 are converged at the focus point F′ which is conjugate to F. The recording reference light impinges on the optical information-recording medium 1 in such a way that the conjugate focus point F′ is located not in the inside of the hologram-recording layer 3, but at a point lower than the interface between the hologram-recording layer 3 and the base plate 2 in FIG. 18 (on the side of the objective 12). This is due to the fact that, if the conjugate focus point F′ is located in the inside of the hologram-recording layer 3, the light exhibits a maximum intensity at the conjugate focus point F′ and the material for the hologram-recording layer 3 burns out, thereby causing the optical information-recording medium 1 to break down.

Although the conjugate focus point F′ can be selected at a point lower than the interface between the hologram-recording layer 3 and the base plate 2, an increased distance departing from the optical information-recording medium 1 provides an increased area through which the recording reference light passes in the hologram-recording layer, thereby causing an extra area other than the interference fringe generating area to be exposed. Accordingly, it is preferable that the conjugate focus point F′ should be located in the inside of the base plate 2, because such an extra area to be exposed may be restricted.

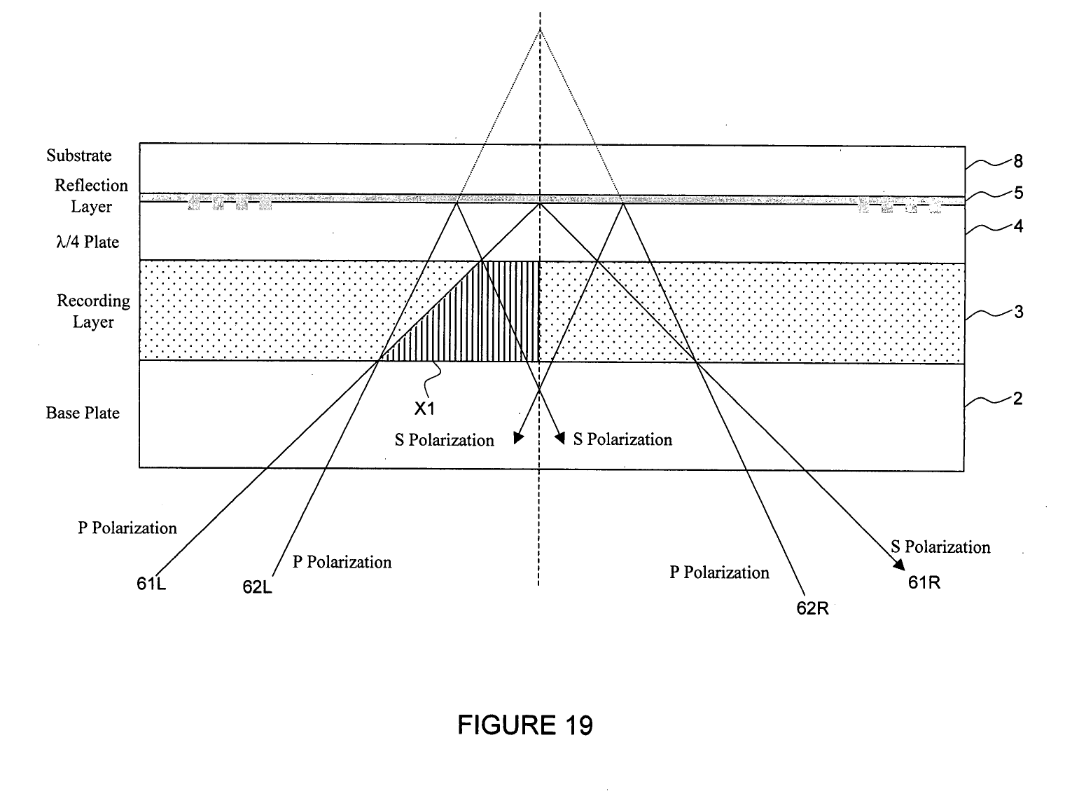

FIG. 19 is a partially enlarged ray diagram in the vicinity of the optical information-recording medium 1. The P-polarized information light 61L and the P-polarized recording reference light 62L interfere with each other to form a transmission type interference pattern (vertical fringes) in an area X1, and then the interference pattern thus formed is three-dimensionally recorded in the area X1 of the hologram-recording layer 3. However, the return light of the recording reference light 62L due to the reflection layer 5 does not interfere with the information light 61L, because the information light 61L is a P-polarized light, but the return light is a S-polarized light, and has no common vibration direction. Hence, the reflection type interference pattern (horizontal fringes) no longer occurs. As described above, a significant feature of the second embodiment resides in the fact that the light before passing through the quarter-wave plate 4 does not interfere with the light which again passes through the quarter-wave plate 4 after reflected by the reflection layer 5, thereby enabling the reflection type interference pattern (horizontal fringes) not to be formed.

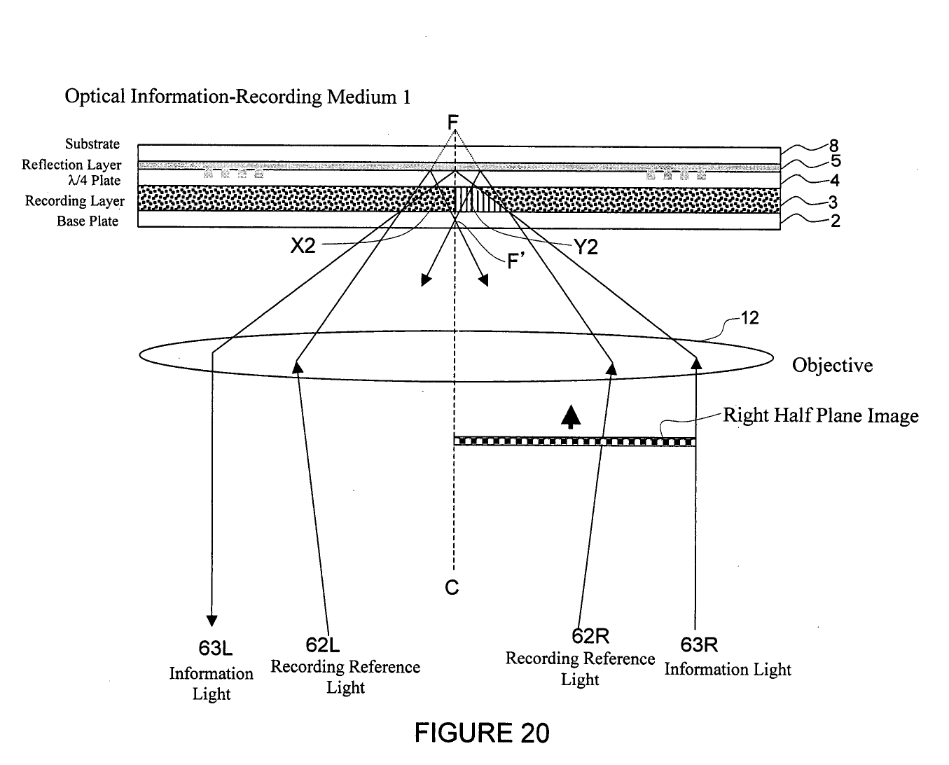

As shown in FIG. 20, the information light 63R (P-polarized light) impinges on the optical information-recording medium 1 via the objective 12, and then passes through the hologram-recording layer 3 and the quarter-wave plate 4 to change into a circularly polarized light. Furthermore, the circularly polarized light is converged in a minimum spot size on the reflection layer 5 and then reflected by the reflection layer 5. The reflected light (information light 63L) again passes through the quarter-wave plate 4 in the circularly polarized state to change from the circularly polarized light to the S-polarized light. Thereafter, the S-polarized light penetrates the hologram-recording layer 3 and is further collimated by the objective 12. The information light 63L has the information on the right half plane of the page data, as similarly to the information light 63R.

Regarding the recording reference light 62L and 62R, a description similar to that in FIG. 18 is applicable and therefore any further description is omitted.

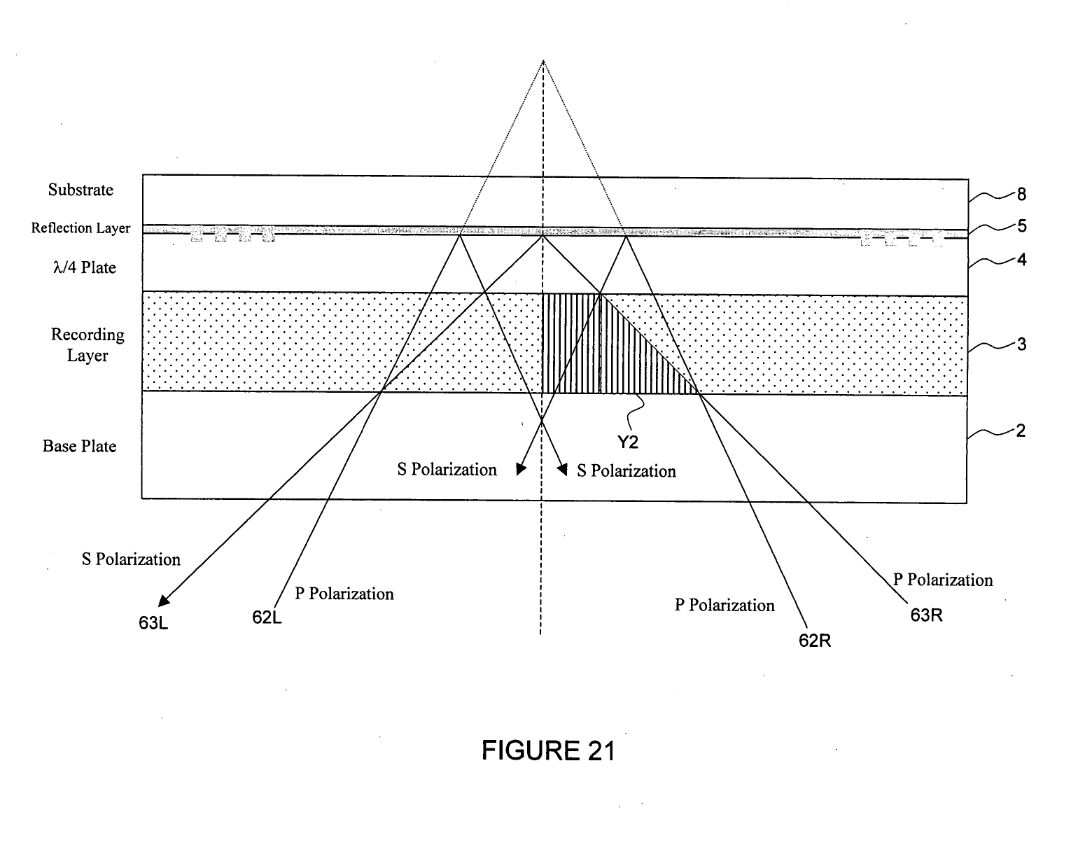

FIG. 21 is a partially enlarged ray diagram in the vicinity of the optical information-recording medium 1. P-polarized information light 63R and P-polarized recording reference light 62R interfere with each other to form a transmission type interference pattern (vertical fringes). The interference pattern is three-dimensionally recorded in an area X1 of the hologram-recording layer 3. However, the return light of the recording reference light after reflected by the reflection layer 5 does not interfere with the information light 63R, because the information light 63R is a P-polarized light but the return light is a S-polarized light and has no common vibration direction. Hence, the reflection type interference pattern (horizontal fringes) no longer occurs. As described above, a significant feature of the second embodiment resides in the fact that the light before passing through the quarter-wave plate 4 does not interfere with the light which again passes through the quarter-wave plate 4 after reflected by the reflection layer 5, thereby enabling the reflection type interference pattern (horizontal fringes) no to be formed.

The behavior of light before and after entering the quarter-wave plate 4 is similar to that in the first embodiment and therefore the description thereof is omitted (see FIG. 8).

Reproducing Operation Mode

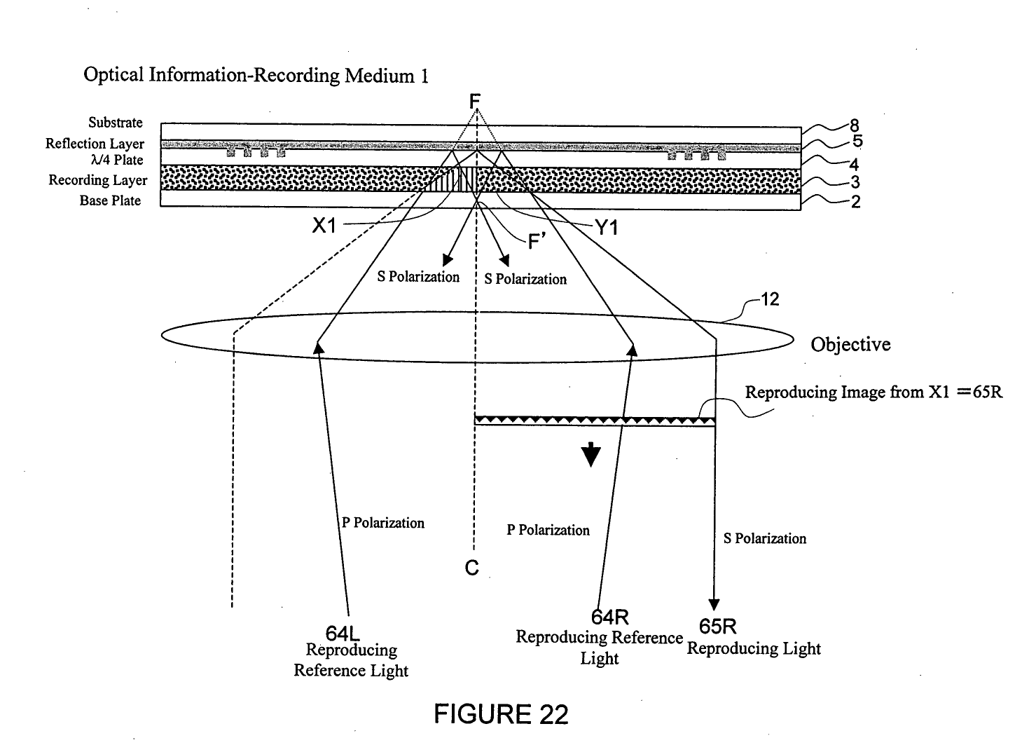

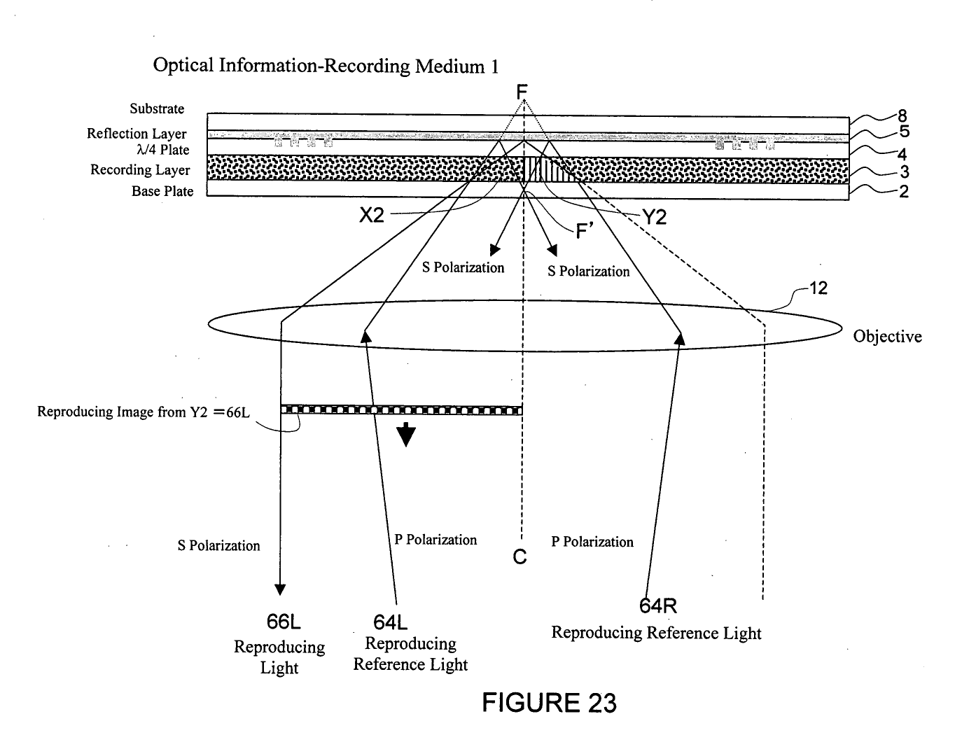

The optical feature of light in the second embodiment till the reproducing light passes through the objective 12 is the same as that in the first embodiment (see FIG. 11). FIGS. 22 and 23 are ray diagrams showing the behavior of light in the reproducing operation mode.

As shown in FIG. 22, the reproducing reference light 64L (P-polarized light) impinges on the optical information-recording medium 1 via the objective 12 and passes through the hologram-recording layer 3 and the quarter-wave plate 4 to change into the circularly polarized light. Furthermore, the circularly polarized light is reflected by the reflection layer 5 and again passes through the quarter-wave plate 4 to change into the S-polarized light. The S-polarized light again passes through the hologram-recording layer 3 and is then converged in a minimum spot size at the focus point F′ which is conjugate to the focus F in the case of no reflection layer 5. In accordance with the above-described irradiation of the reproducing reference light, the reproducing light 65R (P-polarized light) corresponding to the information light 61L (left half plane image on DMD=left half page data) in the recording operation mode is generated from the area X1 of the hologram-recording layer 3. The reproducing light 65R is the light, which is generated from the vertical fringes appearing in X1. The reproducing light 65R thus generated passes through the quarter-wave plate 4 to change into the circularly polarized light. The circularly polarized light is converged in a minimum spot size on the reflection layer 5 and is then reflected by the reflection layer 5. Moreover, the reflected light (information light 65R) again passes through the quarter-wave plate 4 to change from the circularly polarized light to the S-polarized light. Thereafter, the S-polarized light passes through the hologram-recording layer 3 and is then collimated by the objective 12. The reflected light is detected by the CCD or CMOS sensor 29.

In the second embodiment, any reflection type interference pattern (horizontal fringes) is not formed in the area Y1, as is different from the first embodiment, and therefore the reproducing light 65R′ no longer occurs.

As shown in FIG. 23, the reproducing reference light 64R (P-polarized light) impinges on the optical information-recording medium 1 via the objective 12, and passes through the hologram-recording layer 3 and the quarter-wave plate 4 to change into the circularly polarized light. Furthermore, the circularly polarized light is reflected by the reflection layer 5 and again passes through the quarter-wave plate 4 to change into the S-polarized light. The S-polarized light again passes through the hologram-recording layer 3 and is converged in a minimum spot size at the focus point F′ which is conjugate to the focus point F in the case of no reflection layer 5. In accordance with the above-described irradiation of the reproducing reference light, the reproducing light 66L (P-polarized light) corresponding to the information light 63R (right half plane image in DMD=right half page data) in the recording operation mode is generated from the area Y2 of the hologram-recording layer 3. The reproducing light 66L is the light, which is generated from the vertical fringes appearing in Y2. The reproducing light 66L thus generated passes through the quarter-wave plate 4 to change into the circularly polarized light. The circularly polarized light is converged in a minimum spot size on the reflection layer 5 and then reflected by the reflection layer 5. Furthermore, the reflected light (information light 66L) again passes through the quarter-wave plate 4 to change from the circularly polarized light to the S-polarized light. Thereafter, the S-polarized light passes through the hologram-recording layer 3 and is then collimated by the objective 12. The reflected light is detected by the CCD or CMOS sensor 29.

In the second embodiment, any reflection type interference pattern (horizontal fringes) is not formed in the area X2, as is different from the first embodiment, and therefore the reproducing light 66L no longer occurs.

The behavior of light before and after entering the quarter-wave plate 4 is similar to that in the first embodiment and therefore the description thereof is omitted (see FIG. 12). A mask for separating the reference light and reproducing light from each other is also similar to that in the first embodiment and therefore the description thereof is omitted (see FIG. 15).

The process of rejecting the stray light in the second embodiment is similar to that in the first embodiment. That is, the stray light (P-polarized light) resulting from the process in which the reproducing reference light is partially reflected by the surface of the base plate 2 or in the side thereof and the stray light (P-polarized light) resulting from the process in which the reproducing reference light goes and returns in the inside of the optical information-recording medium 1 have an vibration direction different from that in the reproducing light (S-polarized light), thereby enabling the stray light to be separated from the reproducing light by the polarizer plate 51.

In the second embodiment, the stray light (P-polarized light) resulting from the optical elements (base plate 2, objective 12 and others) closer than the quarter-wave plate 4 on the incident side of the reproducing reference light has an vibration direction different from that in the light (S-polarized light) resulting from the process in which the reproducing light generated from the hologram-recording layer 3 according to the incidence of the reproducing reference light leaves the optical information-recording medium 1. As a result, the stray light and the reproducing light can be distinguished from each other, thereby making it possible to prevent the S/N ratio from deteriorating due to the stray light.

In addition, the recording reference light (P-polarized light) used for recording the information in the hologram-recording layer 3 has an vibration direction different from that of the reflected light which results from the process where the recording reference light is reflected by the reflection layer 5 and the reflected light impinges on the hologram-recording layer 3. Hence, no hologram is formed by the reflected light, even if a hologram is formed by the interference of the recording reference light with the information light (P-polarized light). Since the reflection type hologram is not formed, the structural arrangement according to the second embodiment is preferable.

While the preferred embodiments have been shown and described, various modifications and substitutions may be made without departing from the spirit and scope of the invention. Accordingly, it is to be understood that the present invention has been described by way of example, and not by limitation.

What is claimed is:

1. An optical information-recording medium, comprising:
an information-recording layer in which information is recorded, utilizing the holography;
a polarization-changing layer for changing the polarizing direction of the light passing therethrough; and
a reflection layer, disposed far away from said information-recording layer and said polarization-changing layer viewed from the incident side of said light, for reflecting said light.

2. An optical information-recording medium according to claim 1, wherein
said polarization-changing layer is disposed closer to said information-recording layer, viewed from the incident side of light, and is in contact with said information-recording layer.

3. An optical information-recording medium according to claim 2, wherein
said information-recording layer is in contact with said reflection layer.

4. An optical information-recording medium according to claim 1, wherein
said polarization-changing layer is disposed far away from said information-recording layer, viewed from the incident side of light, and is in contact with said reflection layer.

5. An optical information-recording medium according to claim 4, wherein
said polarization-changing layer is in contact with said information-recording layer.

6. An optical information-recording medium according to one of claims 1 to 5,
wherein said polarization layer comprises:
a base plate; and
a phase difference-generating layer for generating a phase difference in the light which is incident on said polarization-changing layer;
whereby molecules in said phase difference-generating layer are arranged along a circle on said substrate.

7. A method for manufacturing a polarization-changing layer which includes a base plate and a phase difference-generating layer for generating a phase difference in the incident light, wherein molecules in said phase difference-generating layer are arranged along a circle on said base plate, said method comprising the following steps of:
applying a phase difference material providing said phase difference-generating layer onto said base plate; and
irradiating a linearly polarized light to said phase difference material in the state of rotating said substrate;
whereby said phase difference material is disposed in a predetermined direction with respect to said linearly polarized light.

8. A method for manufacturing a polarization-changing layer according to claim 7, wherein
said phase difference material is azobezene, and
said linearly polarized light has an oscillating plane which is aligned in the radial direction of rotation when said base plate is rotated.

9. A method for manufacturing a polarization-changing layer which includes a base plate having an orientation layer on the surface and a phase difference-generating layer for generating a phase difference in the incident light, wherein molecules in said phase difference-generating layer are arranged along a circle on said base plate, said method comprising the following steps of:
rubbing said orientation layer;
applying a phase difference material providing said phase difference-generating layer onto said base plate; and
rotating said base plate.

10. An optical information recording apparatus for recording information in an optical information-recording medium according to one of claims 1 to 6, said optical information recording apparatus comprising:
an information light generating unit for generating information light carrying information;
a recording reference light generating unit for generating recording reference light; and
a recording optics for irradiating information light and recording reference light onto information-recording layer from one side thereof to record the information on said information-recording layer of said optical information-recording medium by means of an interference pattern provided by interfering said information light and said recording reference light with each other.

11. An optical information reproducing apparatus for reproducing information from an optical information-recording medium according to one of claims 1 to 6, said optical information reproducing apparatus comprising:
a reproducing reference light generating unit for generating reproducing reference light;
a reproducing optics for collecting reproducing light from information-recording layer of said optical information-recording medium on the same side of said reproducing reference light irradiated onto said information-recording layer by irradiating said reproducing reference light onto said information-recording layer; and
a detection unit for detecting the reproducing light collected by said reproducing optics.

12. An optical information reproducing apparatus according to claim 11, further comprising;
a noise suppressing unit interposed between said reproducing optics and said detection unit for penetrating only a linearly polarized light which has the same vibration direction as that in the circularly polarized light penetrating the polarization-changing layer of said optical information-recording layer.
